(19) United States
(12) Patent Application Publication
(10) Pub. No.: US 2006/0101735 A1
(43) Pub. Date: May 18, 2006

(54) Integrally reinforced plastic molded components and products

(75) Inventor: Arthur Silverman, Warren, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Silver Line Building Products Corp., North Brunswick, NJ (US)

(21) Appl. No.: 10/953,385

(22) Filed: Sep. 29, 2004

(51) Int. Cl. E06B 1/04

(52) U.S. Cl. 52/204.1

(57) ABSTRACT

The present invention relates to integrally reinforced plastic molded components and products, such as patio door assemblies. In particular, a reinforced unitary patio door frame is disclosed having a plurality of sash members integrally molded and connected to one another, one of the plurality of sash members having an integrally molded reinforcing bar and a plastic retention member integrally formed with the frame, in which the plastic retention member holds the reinforcing bar within the frame. The disclosures herein are also applicable to methods of making such a reinforced unitary patio door frame as well as other types of objects requiring reinforcing members, such as windows, benches, or tables.

The present invention relates to integrally reinforced plastic molded components and products, such as patio door assemblies, and more particularly, to such integrally reinforced plastic molded components and products having an integral reinforcing member and integrally molded retention straps for holding the reinforcing member within the component or product, as well as to a method for making such integrally reinforced plastic molded components and products using injection molding. The present invention will be described mainly with reference to a patio door assembly, but it will be appreciated that the present invention also relates to reinforcing other types of objects as well.

It is known in the art to extrude or mold various component parts for all types of objects, such as component parts for windows, patio doors, machines, automobiles and the like. The parts are then assembled together with other component parts to create a finished and completed product. In the patio door assembly art, known extrusion and molding processes are used to make horizontal and vertical sash members for patio door frames, commonly referred to as sash rails and sash styles, respectively. Such known extrusion and molding processes only permit portions of a patio door frame assembly, such as a single sash rail, to be extruded or molded at a given time. This is because patio door assemblies must generally be constructed to accommodate two patio doors, namely a fixed patio door and a movable patio door. A patio door assembly is typically at least 5 feet in width and at least 6 feet 8 inches in height, a size that has been thought to be too difficult to mold all at one time.

Accordingly, individual sash rails and sash styles of the patio door assembly are first separately extruded. In order to meet structural codes and wind loads, the patio door assembly must typically be reinforced with metal or other reinforcing materials. Once the separate components of the patio door assembly are extruded, a reinforcing bar must be installed into one of the sash members (e.g., the sash rail or sash style) to reinforce the frame. Only when the reinforcing bar is installed is it possible to attach or assemble the separately extruded sash members (e.g., the individual sash rails and sash styles) together at each of their respective ends to form the patio door assembly frame. Typically, the separate sash members are connected together by welding or the use of screws.

There are several drawbacks associated with known patio door assemblies and methods of making same. It is time consuming and costly to separately extrude or mold the individual sash members of the patio door frame, and then assemble them together. This requires additional materials to connect the sash members at their respective ends, as well as additional labor and machinery to properly connect the sash members together. The intermediate step of inserting a reinforcing bar and a corresponding sash strap to secure the reinforcing bar within a sash member further adds to the parts, labor, and time necessary to complete the patio door frame. The additional time, parts, and labor required to construct known patio door frames reduces the output of manufactured frames, while increasing manufacturing costs. Indeed, each of these costs is then passed on to the consumer.

In view of the need to reduce costs and production time for the creation of reinforced component parts, it would therefore be beneficial to provide a patio door assembly frame that has an integrally molded reinforcing bar or member, as well as a method for providing a reinforced patio door assembly in its entirety. Furthermore, it would be beneficial to create a method of reinforcing products that can be used for the creation of other objects, such as windows, chairs and the like.

### SUMMARY OF THE INVENTION

The present invention is designed to overcome the shortcomings associated with prior art plastic molded components and products, such as reinforced patio door assemblies, by providing a reinforced molded plastic component or product having an integral reinforcing member which is integrally secured therewithin. Advantageously, the reinforced molded plastic component or product may be manufactured using an injection molding process, such as a gas or liquid assist injection molding process. In accordance with the present invention, the reinforced molded plastic component or product has a reduced number of parts and requires fewer steps for its manufacture, thus reducing the cost to manufacture.

In accordance with one aspect of the present invention, there is provided a reinforced injection molded plastic product which includes a plastic body comprised of plastic material injection molded into a size and shape corresponding to the size and shape of the product to be reinforced, a reinforcing member for reinforcing the plastic body, and at least one integral retention member. The reinforcing member is arranged so as to be in intimate contact with the plastic material comprising the plastic body about a first portion of the circumference of the reinforcing member at the time the plastic material is injection molded into the plastic body. The at least one integral retention member is comprised of the same plastic material forming the plastic body, and is integrally formed with the plastic material at the time the plastic body is injection molded. The integral retention member is disposed so as to extend about a second portion of the circumference of the reinforcing member so as to retain the reinforcing member in the plastic body. In accordance with a preferred embodiment, the reinforcing member may comprise an elongated reinforcing bar for reinforcing the plastic body along a longitudinal dimension of the plastic body. In accordance with a still further preferred embodiment, the elongated reinforcing bar may comprise a flat reinforcing bar having a first side and a second side, the flat reinforcing bar being arranged so that the first side thereof is in intimate contact with the plastic material of the plastic body substantially along the length of the flat reinforcing bar, and the integral retention member being arranged to extend across a portion of the second side of the flat reinforcing bar and to be integral with the plastic material of the plastic body.

In accordance with a further aspect of the present invention, the reinforced injection molded plastic product comprises a unitary door frame in which the plastic body includes a plurality of sash members integrally formed with one another and connected together at their respective ends, and wherein the reinforcing member is arranged in one of the sash members in intimate contact with the plastic material, with the at least one integral retention member being disposed so as to extend across a reinforcing member and to be integral with the plastic material of the one sash style. Preferably, a plurality of retention members are provided along the length of the sash member. The unitary door frame may comprise a unitary outer frame for a patio door assembly in which four sash members made of injection molded plastic material are integrally formed and connected together at their respective ends to form the shape of a rectangle and in which an intermediate sash member made of the same injection molded plastic material is integrally formed with the four sash members and extends between two of the sash members forming the rectangle, with the reinforcing member provided in the intermediate sash member. In accordance with a further embodiment of the present invention, the unitary door frame may comprise a moveable door frame of a patio door assembly.

Alternatively, the reinforced injection molded plastic product may comprise a table in which the plastic body includes a table top and a depending lip around the circumference thereof, with the reinforcing member being arranged so as to be disposed in the depending lip. In accordance with a further aspect of the present invention, the reinforced injection molded plastic product may comprise a window in which the plastic body includes two sash rails and two sash styles integrally formed with one another and connected together at their respective ends, and in which the reinforcing member is arranged to be disposed in one of the sash rails and sash styles. In accordance with a still further aspect of the present invention, the reinforced injection molded plastic product may comprise a bench in which the plastic body includes a seat and a dependent lip, and in which the reinforcing member is arranged to be disposed in the depending lip.

In accordance with another aspect of the present invention, there is provided a method of making a reinforced injection molded object from an injection moldable plastic material. In accordance with the method, there is provided a mold having a mold cavity in a desired shape for injection molding the object, the mold including a support mechanism operable to engage a reinforcing member to support the reinforcing member in a predetermined position in the mold cavity so that the injection moldable plastic material will intimately contact the reinforcing member about at least a first portion of the reinforcing member, and with the mold cavity also being constructed so that the injection moldable plastic material will extend about a second portion of the reinforcing member to form an integral retention member integrally formed with the injection moldable plastic material in intimate contact with the first portion of the reinforcing member for retaining the reinforcing member in intimate contact with the injection moldable plastic material. In accordance with the method, a reinforcing member is placed in the cavity of the mold and the support mechanism is operated to engage the reinforcing member to support the reinforcing member in the mold cavity in the predetermined position. Injection moldable plastic material in a viscous state is then injected into the mold cavity to intimately contact the reinforcing member. The viscous plastic material is then allowed to solidify, and the support mechanism is then disengaged from the reinforcing member and the solidified plastic material then removed from the mold.

In accordance with a preferred embodiment, the reinforcing member comprises a longitudinally extending reinforcing bar, and more preferably, the reinforcing member is a flat reinforcing bar having a first side and a second side. The mold cavity is constructed so that the injection moldable plastic material will contact the flat reinforcing bar along the first side, and also constructed so that the injection moldable plastic material will also extend about at least a portion of the second side of the flat reinforcing bar. In accordance with a still further preferred embodiment, the injection moldable plastic material contacts the first side of the flat reinforcing bar along substantially the length of the flat reinforcing bar. In accordance with a further embodiment of the present invention, the flat reinforcing bar also has two edges extending between the first and second sides, and the mold cavity is constructed so that the injection moldable plastic material will contact the first and second sides and one of the edges of the flat reinforcing bar along substantially the length of the flat reinforcing bar, and also constructed so that the injection moldable plastic material will also extend about at least a portion of the other of the edges of the flat reinforcing bar.

In accordance with a preferred embodiment, the support mechanism comprises a magnet operable to magnetically hold the reinforcing member. Alternatively, the support mechanism may be comprised of a retractable pin operable to move between an extended position in which it engages the reinforcing member and a retracted position in which it is disengaged from the reinforcing member.

In accordance with a further aspect of the present invention, the method may be utilized for making a reinforced unitary door frame from an injection moldable plastic material. In accordance with this aspect of the present invention, the mold has a mold cavity in the shape of a rectangular door frame having a plurality of sash members connected to one another. Alternatively, the foregoing method may be utilized for making an object such as a table or a window or a bench, or any other like object in which it is desired to reinforce the plastic body.

Therefore, in accordance with the present invention, various integrally reinforced molded plastic components and products, and methods of making them, are disclosed which overcome the shortcomings of the prior art. These and other features and characteristics of the present invention will be apparent from the following detailed description of preferred embodiments, which should be read in light of the accompanying drawings in which corresponding reference numbers refer to corresponding parts throughout the several views.

### BRIEF DESCRIPTION OF THE DRAWINGS

FIG. 1 is a perspective view of the inside of a unitary patio door assembly in accordance with one aspect of the present invention.

FIG. 2 is a perspective view of the outside of unitary patio door assembly frame shown in FIG. 1, with the moveable door unit and insulated glass units being removed for illustrative purposes.

FIG. 3 is an elevational view of the unitary patio door assembly frame shown in FIG. 2.

FIG. 4 is a perspective cross-sectional view of portions of the left reinforced sash style and bottom sash rail of the unitary patio door assembly frame shown in FIG. 2.

FIG. 5 is a schematic view of the unitary patio door assembly frame shown in FIGS. 2 and 3 as it undergoes shrinkage.

FIG. 6 is a perspective cross-sectional view of portions of the bottom sash rail and right sash style of the unitary patio door assembly frame shown in FIG. 2.

FIG. 7 is a perspective cross-sectional view of a portion of the left reinforced sash style of the unitary patio door assembly frame shown in FIG. 2, with an insulated glass unit installed therein.

FIG. 8 is an elevational view of the outside of the movable patio door, which is a part of the patio door assembly shown in FIG. 1.

FIG. 9 is a perspective view of the bottom sash rail and right sash style of the moveable patio door shown in FIG. 8.

FIG. 10 is a perspective view of a portion of the mold for producing the patio door assembly frame shown in FIG. 4, as well as a portion of the molded sash style, in accordance with another aspect of the present invention, illustrating in particular a portion of the left reinforced sash style having the integral reinforcing bar therein, as viewed from the inside of the patio door assembly.

FIG. 11 is a perspective cut-away view of a portion of the mold shown in FIG. 10, illustrating a preferred mechanism for positioning of the reinforcing bar during molding of the patio door assembly frame.

FIG. 12 is perspective view of another portion of the mold for producing the patio door assembly frame shown in FIG. 4, as well as a portion of the molded sash style in accordance with the present invention, illustrating the other mold half from that illustrated in FIG. 10 and in which the sash style is viewed from the outside of the patio door assembly.

FIG. 13 is a perspective cross-sectional view of portions of the left reinforced sash style of the unitary patio door assembly and the right reinforced sash style of the moveable patio door, shown in mating relationship to one another.

FIG. 14 is a perspective cross-sectional view of the same sash styles shown in FIG. 13 but taken along different portions of the length thereof, to illustrate the integral interlock mechanism holding the two sash styles together.

FIG. 15 shows an alternative arrangement for holding a reinforcing bar within a mold to produce an integrally reinforced plastic molded component or product in accordance with the present invention.

FIG. 16 shows a further alternative way in which to hold a reinforcing bar within a mold to produce an integrally reinforced plastic molded component or product in accordance with the present invention.

FIG. 17 is a perspective view of the bottom side of a table having reinforcing bars in accordance with another aspect of the present invention.

FIG. 18 is a detailed cut-away portion of the table shown in FIG. 17.

FIG. 19 is a schematic view of a mold for producing the reinforced table shown in FIG. 17.

FIG. 20 is a perspective view of a bench having reinforcing bars in accordance with a further aspect of the present invention.

FIG. 21 is a perspective cut-away view of the bench shown in FIG. 20.

FIG. 22 is a detailed cut-away view of a portion of the portion of the bench shown in FIG. 21.

FIG. 23 is a perspective view of a window assembly having a reinforced meet rail in accordance with a further aspect of the present invention.

FIG. 24 is a perspective view of a portion of the meet rail shown in FIG. 23.

### DETAILED DESCRIPTION OF THE DRAWINGS

In describing the preferred embodiments of the subject matter illustrated and to be described with respect to the drawings, specific terminology will be resorted to for the sake of clarity. However, the invention is not intended to be limited to the specific terms so selected and it is to be understood that each specific term includes all technical equivalents which operate in the same or a similar manner to accomplish the same or a similar purpose.

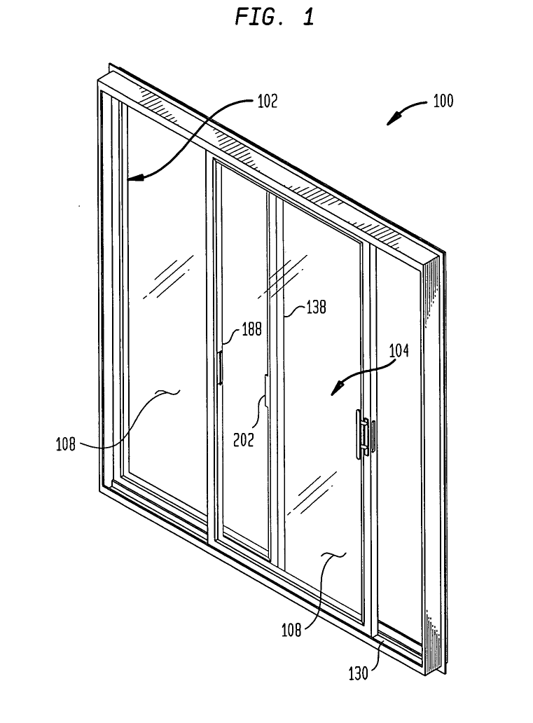

FIG. 1 illustrates one example of an integrally reinforced molded plastic product in accordance with the present invention. More particularly, the integrally reinforced molded plastic product shown in FIG. 1 comprises a patio door assembly 100 having a reinforcing bar (not shown) integrally molded within at least one of the sash members. The patio door assembly 100 is comprised of two major components: an injection molded unitary patio door assembly frame 102, and an injection molded movable patio door frame 104 which fits in and is able to move within the unitary patio door assembly frame 102. In accordance with one aspect of the present invention, each of the two major components 102 and 104 is integrally reinforced with a reinforcing bar (not shown) provided along the vertical center sash members or styles 138, 188. Once each of these two major components 102, 104 is molded, insulated glass units 108 are installed into each of the respective frames, and the moveable patio door frame 104 is then installed in the unitary patio door assembly frame 102 to provide a completed patio door assembly 100.

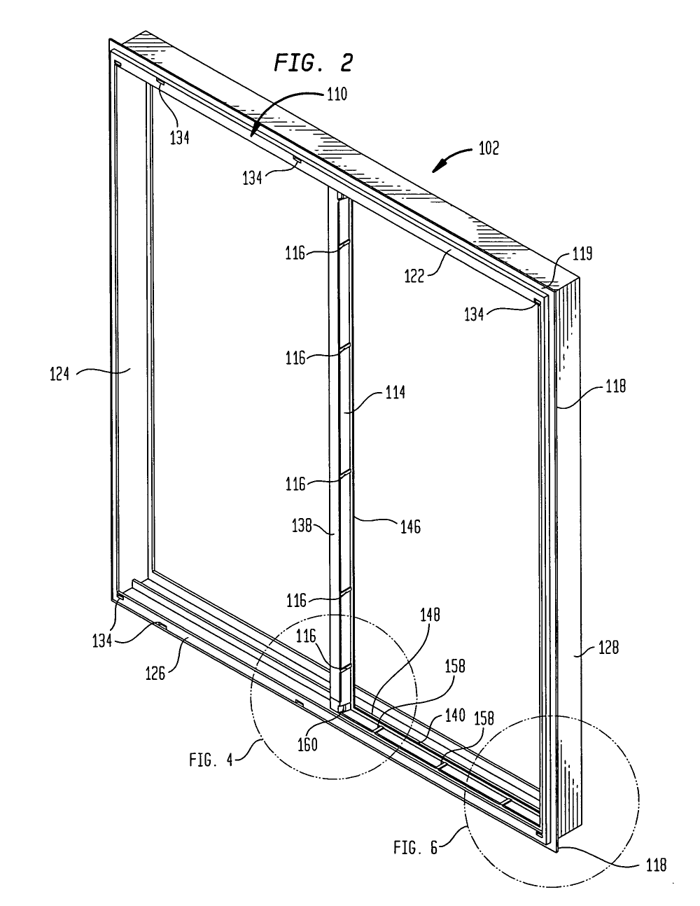

It should be appreciated that the patio door assembly 100 shown in FIG. 1 is a completely assembled patio door assembly that has been manufactured using an injection molding process, preferably a gas- or liquid-assist injection molding process. As will be discussed in greater detail herein, prior to the installation of the insulated glass units 108, the unitary patio door assembly frame 102 and movable patio door frame 104 each undergo shrinkage as a result of the injection molding process i.e., the process used to create the shape and size of the unitary patio door assembly frame 102 and the movable patio door frame 104. However, in order to illustrate important features of the invention that are present and visible prior to the occurrence of shrinkage, and prior to the installation of the insulated glass units 108, FIGS. 2-4, 6, 8 and 9 illustrate embodiments of the unitary patio door assembly frame 102, and the movable patio door frame 104, respectively, prior to the occurrence of shrinkage.

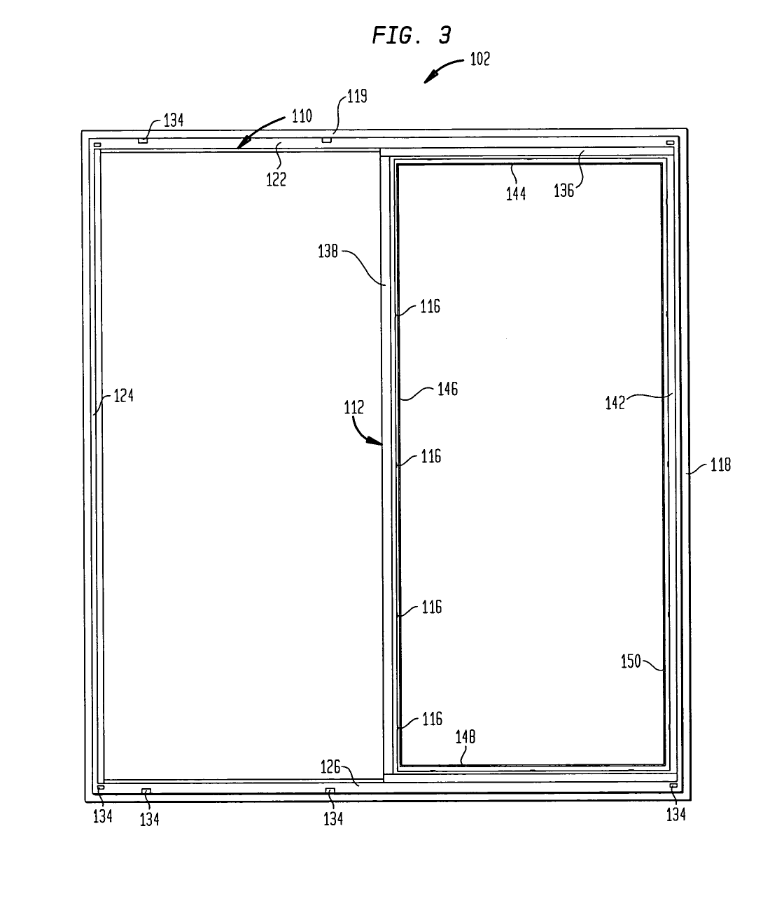

Referring to FIGS. 2 and 3, the unitary patio door assembly frame 102 in accordance with the present invention is shown from the outside, or opposite from the side shown in FIG. 1. Also, the moveable patio door frame 104 has not yet been installed in the unitary patio door assembly frame 102, nor have the insulated glass units 108. The unitary patio door assembly frame 102 is rectangular in shape and is comprised of a fixed outer frame 110, and a fixed inner frame 112. As shown and described more fully hereinbelow, the fixed inner frame 112 in accordance with the present invention includes an integral reinforcing bar 114 retained by means of integral retention or securing members or straps 116 in the vertical style 138 of the inner frame 112. Advantageously, and as will be described, the integral reinforcing bar 114 is supported in the mold cavity used for injection molding the unitary patio door assembly frame 102 so that the injection molded plastic, including the integral retention members 116, are molded around the reinforcing bar 114 so as to produce a unitary patio door assembly frame 102 having the integral reinforcing bar 114 retained therewithin, as opposed to adding the reinforcing bar after injection molding of the patio door assembly frame.

As shown in FIGS. 2-4, the unitary patio door assembly frame 102 includes a mounting fin 118 which comprises a band that surrounds the outer perimeter of the unitary patio door assembly frame 102. When it is desired to install the unitary patio door assembly frame 102 into the doorway of a structure, the fin 118 is used as a primary means of attachment. Preferably, the fin 118 is nailed or screwed into the doorway, although any suitable means of attachment is appropriate. The fin 118 is designed so that, if necessary, a portion of the fin 118 can be cut off or separated from the unitary patio door assembly frame 102, while leaving the remainder of the unitary patio door assembly frame 102 intact. Due to the size of standard doorways, the top 119 of the fin 118 is often cut away, while the remainder of the fin 118 is used to attach the unitary patio door assembly frame 102 into the doorway of a structure.

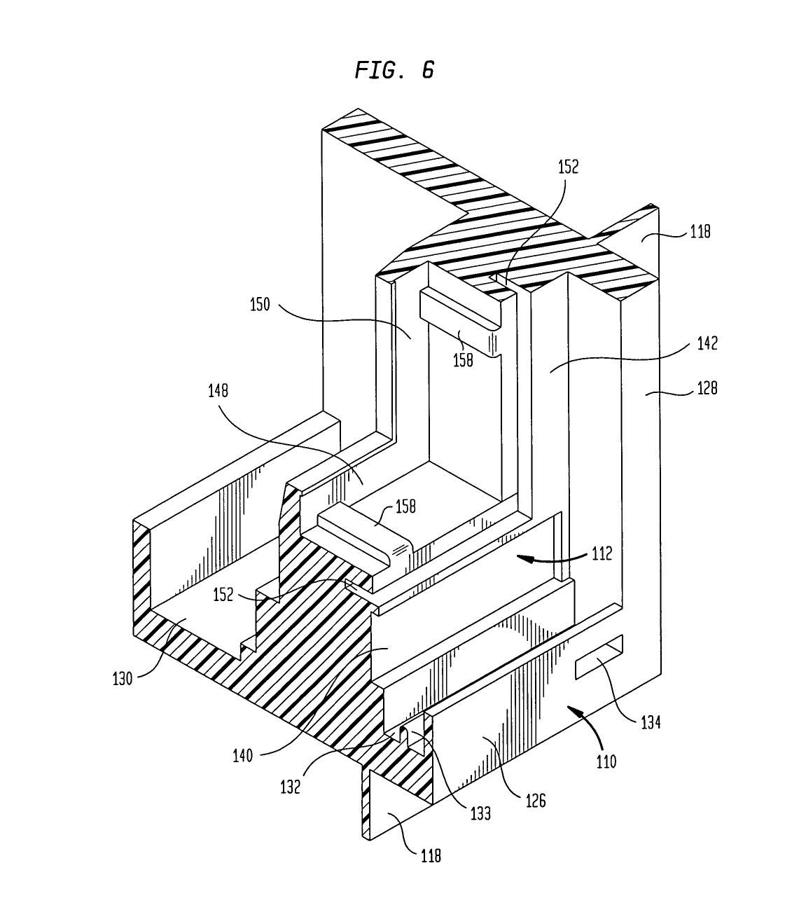

The fixed outer frame 110 of the unitary patio door assembly frame 102 is comprised of several horizontal and vertical sash members, which are commonly referred to as sash rails and sash styles, respectively. The fixed outer frame 110 has an outer top sash rail 122, an outer left sash style 124, an outer bottom sash rail 126, and an outer right sash style 128, that are integrally formed and connected together at their respective ends. As best seen in FIGS. 3 and 6, the outer top and bottom sash rails 122, 126 preferably have wider outer faces than the outer left and right sash styles 124, 128. The fixed outer frame 110 is rectangular in shape and serves as the primary structure to house both a fixed patio door and a movable patio door.

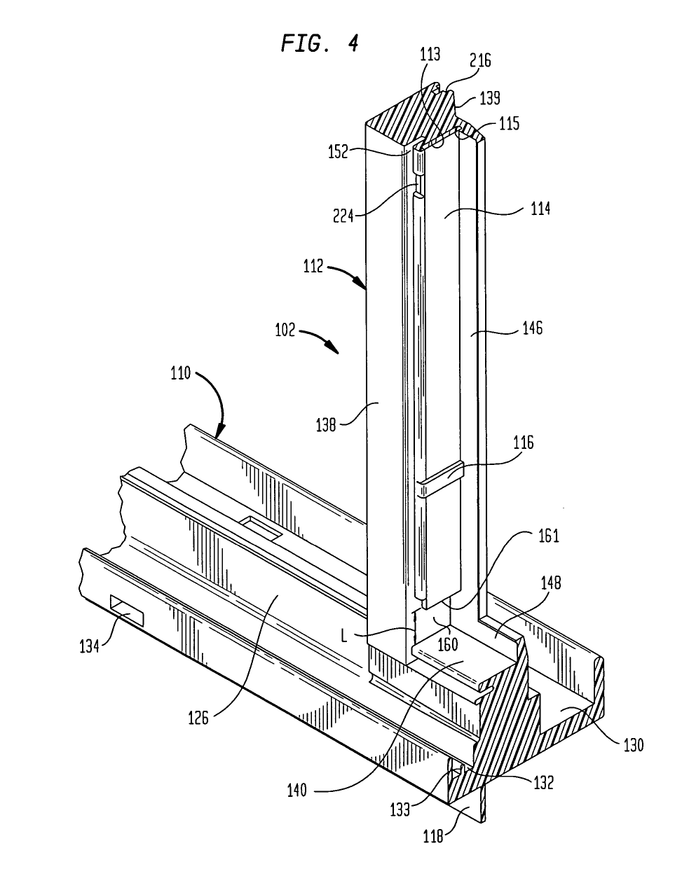

Each of the outer top and bottom sash rails 122, 126 are constructed to provide inside and outside channels 130, 132 for the moveable patio door and a screen, respectively. These channels 130, 132 are best seen with reference to FIGS. 4 and 6. The inside channel 130 is slightly larger than the thickness of the moveable patio door assembly frame 104, and the moveable patio door assembly frame 104 is designed to move left to right within the channel 130. The outside channel 132 includes a raised bead 133 which serves as a track along which a screen door may travel. As best seen in FIGS. 2, 3, 4, and 6, weep holes 134 are provided along the outer top sash rail 122 and outer bottom sash rail 126, to provide a means for water to drain out of the patio door assembly 100 after installation. As explained more fully hereinbelow, the unitary patio door assembly frame 102 is designed to be installed in the orientation shown in FIG. 1 with the moveable patio door assembly frame 104 being a right hand door, or installed with the outer top sash rail 122 on the bottom and the outer bottom sash rail 126 on the top, i.e., rotated 180°, so that the moveable patio door assembly frame 104 is on the left to provide an opening left hand door. Accordingly, weep holes 134 need to be provided in both the outer top rail 122 and the outer bottom rail 126 to allow drainage irrespective of the orientation of the unitary patio door assembly 102.

Referring to FIG. 3, the unitary patio door assembly frame 102 further includes a smaller fixed inner frame 112 that is located within and integrally formed with the fixed outer frame 110. The fixed inner frame 112 is comprised of an inner top sash rail 136, an inner left reinforced sash style 138, an inner bottom sash rail 140, and an inner right sash style 142. The inner sash rails and styles 136-142 are integrally formed and connected together at their respective ends, as well as integrally connected and formed with approximately half of the fixed outer frame 110, i.e., the right half as shown in FIGS. 2 and 3. Thus, it will be appreciated that the inner left reinforced sash style 138 extends between the inner top and bottom sash rails 136, 140 which in turn are integral with the outer top and bottom sash rails 122, 126, respectively, but only extend horizontally approximately one-half the width of the unitary patio door assembly frame 102. Also, the inner right sash style 142 is integrally formed with the outer right sash style 128.

As best seen in FIGS. 3, 4 and 6, the fixed inner frame 112 further comprises an inwardly extending top support ledge or lip 144, an inwardly extending left support ledge or lip 146, an inwardly extending bottom support ledge or lip 148, and an inwardly extending right support ledge or lip 150, each extending from their respective sash rails or sash styles and also connected to one another at their respective ends. The inwardly extending support ledges 144-150 provide a wall or support surface that an insulated glass unit (not shown) can lie against once the insulated glass unit is assembled into the fixed inner frame 112. Once the insulated glass unit 108 is secured within the fixed inner frame 112, the fixed inner frame 112 and insulated glass unit 108 serve as a fixed patio door of the unitary patio door assembly 100.

Referring to FIG. 4, there is shown an exploded perspective view of a portion of the inner left reinforced sash style 138 at the point where it intersects the inner bottom rail 140. As best seen in FIG. 4, the inner left reinforced sash style 138 includes along its outside face a vertically extending glazing bead slot 152 for receiving a glazing bead 154 (not shown in FIG. 4) and has an integrally retained reinforcing bar 114 that extends vertically along substantially the entire length of the sash style 138. The surface of the reinforcing bar 114 is exposed and faces inwardly, and is retained by means of integral retention members or straps 116 that extend across the exposed surface of the reinforcing bar 114 between the inside and outside portions of the sash style 138.

As best seen in FIG. 4, and as will be apparent from the description hereinbelow of the molding process used in a preferred embodiment for producing the unitary patio door assembly 102, the reinforcing bar 114 in the embodiment shown is integrally formed in the sash style 138 with molded plastic enclosing it on three sides (i.e., the two edges of the bar 114 and one of the wide flat surfaces), and with the retention members or straps 116 extending at spaced locations across the fourth side (i.e., the other flat surface) of the reinforcing bar 114. The retention members or straps 116 serve to hold the reinforcing bar 114 in place. Thus, in effect, the molded plastic encasing the reinforcing bar 114 defines a “channel” 113 for the reinforcing bar 114. The vertical edge of the reinforcing bar 114 adjacent to the inside portion of the sash style 138, in a preferred embodiment, is disposed in a “groove” 115 formed between the left support ledge or lip 146 and the sash style 138. The channel 113 and the groove 115 serve to assist in positioning the reinforcing bar 114 within the inner left reinforced style 138, with the securing or retention straps 116 extending across the other surface of the reinforcing bar 114 to retain it in position. In a preferred embodiment, as shown in FIG. 2, five retention straps 116 extend at spaced intervals along the entire length of the inner left reinforced sash style 138. It should be appreciated, however, that any number of retention straps 116 may be used; in fact, only one is required. The retention straps 116 are integrally formed with the plastic defining the channel in which the reinforcing bar 114 is disposed so that the reinforcing bar 114 is securely and integrally retained within the reinforced sash style 138. The retention straps 116 also act as separators to protect the insulated glass unit 108 from contacting the steel reinforcing bar 114.

A glazing bead slot 152 is provided in the outside face of the reinforced sash style 138 directly behind and adjacent the reinforcing bar 114, and extends along the length of the inner left reinforced sash style 138. The glazing bead slot 152 is adapted to receive a glazing bead 154 to hold an insulating glass unit 108 in place against the inwardly extending ledge or lip 146. This can best be seen in FIG. 7. Similar glazing bead slots 152 are provided along the inner right sash style 142 (see FIG. 6), as well as along the inner top and bottom sash rails 136, 140 (see FIG. 4 and FIG. 6).

It should be appreciated that in most instances, it is only necessary for one of the sash styles 138, 142 to have an integral reinforcing bar 114; however, depending on building requirements and/or customer preferences, integral reinforcing bars 114 may be provided in more than one sash member. In a preferred embodiment, the reinforcing bar 114 is preferably made of cold rolled steel with dimensions of about 6 feet long and ⅛ “thick by 1 3/16” wide, although the dimensions of the reinforcing bar 114 may be altered according to building code requirements. Reinforcing bars 114 generally help to reinforce the patio door assembly 100 in storm conditions, and are also required to meet structural codes and wind loads. The reinforcing bar 114 helps to prevent buckling of the patio door assembly 100 at its weakest point, which is at the center of the patio door assembly 100. The weakest point of the patio door assembly 100 is therefore the inner left reinforced style 138, and in the embodiment shown in FIG. 4, the inner left reinforced style 138 is the only sash style with a reinforcing bar 114. In this regard, the inner right style 142, inner top rail 136, and inner bottom rail 140 are identical to one another, and do not have a reinforcing strap 116 or reinforcing bar 114.

In a preferred embodiment, the retention strap 116 is approximately 0.5 inches wide. As will be described in greater detail herein, the retention strap 116 is integrally molded with the other components of the inner left reinforced style 138 of the patio door assembly 100, and does not need to be installed after completion of the molding process. The integrally molded retention strap 116 is therefore an improvement over prior art patio door assemblies, wherein manual attachment of the sash straps is required after extrusion or molding of the sash. It should be appreciated that the retention strap 116 is a means for securing the reinforcing bar 114 within a sash member during the molding process. Accordingly, various embodiments of an integrally molded retention strap 116 may be utilized, such as integrally molded notches or a criss-cross strap design. It should be further appreciated that instead of straps 116 having a relatively narrower width, straps having a substantially greater width could be provided to provide more plastic material molded around the steel reinforcing bar 114 to hold it in place, such that less of the steel bar 114 would be visible. What is important in the present invention, however, is to provide a firm or hard surface in the mold against which the steel reinforcing bar 114 is placed in order to properly locate or position the steel bar 114 in the mold and hold it in place during injection of the viscous plastic material, as more fully described hereinbelow. Thus, some portion of the steel reinforcing bar 114 will be exposed or visible in the finished product.

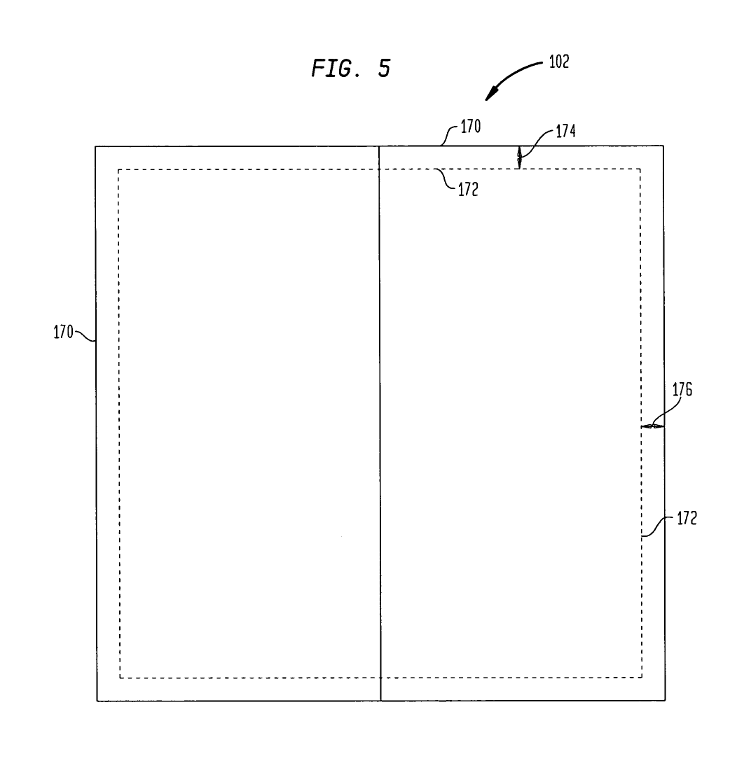

As previously discussed, shrinkage of the unitary patio door assembly frame 102 occurs during the molding process. Shrinkage occurs once a mold of the patio door assembly frame 102 is filled with a viscous material used to form the patio door structure, and the viscous material begins hardening into the final patio door structure. When the material begins to harden, the sash rails and styles of the unitary patio door assembly frame 102 (and the movable patio door assembly frame 104 as well (see FIG. 1)) will begin to contract at their respective tops, bottoms and sides, much like a rubber band that is stretched apart and then released. As shown in the schematic of FIG. 5, depending on the size of the product being molded, the frame 102 will uniformly shrink or contract, from the size indicated by the solid lines 170 to the size indicated by the dashed lines 172. The amount of shrinkage is indicated by the double headed arrows 174, 176. Thus, in accordance with the present invention, the unitary patio door assembly frame 102 (and the movable patio door frame 104 as well) are designed to allow for shrinkage. The shrinkage process often deterred those in the art from contemplating a design having a reinforcing bar integrally molded with the unitary patio door assembly frame. This is because shrinkage of the unitary patio door assembly frame 102 was thought to cause the reinforcing bar 114 to bend and/or twist as the unitary patio door assembly frame 102 shrunk, since the reinforcing bar 114 does not itself shrink. Thus, manufacturers were forced with prior art designs to install a reinforcing bar after completion of the extruding process.

In accordance with another important feature of the present invention, the unitary patio door assembly frame 102 is designed to allow for shrinkage of the unitary patio door assembly frame 102 in a manner so that a reinforcing bar 114 can be integrally retained during the injection molding process. As will be discussed in greater detail herein, the reinforcing bar 114 is designed to have a length which corresponds to the finished dimension of the sash style 138 in which it is to be located, after the sash style 138 fully cures and has shrunk. This means that the sash style 138 will initially have a longer dimension than the reinforcing bar 114. In a sense, as shown in FIG. 4, the inner left reinforced style 138 initially has excess plastic material in comparison to the length of the reinforcing bar 114, so as to initially provide a space between the end of the bar 114 and the corner of the sash style 138 and sash rail 140 in order to accommodate shrinkage thereof. A similar space is provided at the top of the bar 114 and the corner of the sash style 138 and the sash rail 136 (see FIG. 3). The failure to provide for an excess amount of material to accommodate shrinkage may otherwise cause the reinforcing bar 114 that is placed within the reinforced sash style 138 during the molding process to bend and twist during shrinking of the sash style 138. This is because the sash style 138 will shrink, but the inherent properties of the reinforcing bar 114 prevent it from shrinking within the sash style 138, thereby resulting in the reinforcing bar 114 bending as the sash style 138 shrinks. Of course, the sash style 138 having the integral reinforcing bar 114 has the same initial dimension as the other sash style 142 of the unitary patio door assembly frame 102, as the shrinkage which occurs after removal of the unitary patio door assembly frame 102 from the mold tends to be uniform. As is well known and understood by persons skilled in the art of injection molding and familiar with injection molding of various plastics, the amount of shrinkage which will be experienced is dependent on the type of plastic material utilized, the temperature and pressure at which the plastic material is injected, the cooling process, and the size of the component being molded.

In a preferred embodiment, the inner left reinforced sash style 138 and the inner right sash style 142, and the outer left and right sash styles 124, 128 (see FIGS. 3 and 4), are all initially designed to be longer than required at their respective top and bottom, so as to accommodate for shrinkage of the unitary patio door assembly frame 102. Similarly, it should be appreciated that shrinkage occurs in both the horizontal and vertical directions. (See FIG. 5.) Thus, the outer and inner rails 122, 126 (see FIGS. 3 and 4) of the unitary patio door assembly frame 102 are all provided with excess length to accommodate shrinkage as well. In other words, the sash members 122-128, 136-142 are all designed with excess material initially to allow for shrinkage of the sash members to the desired finished dimensions. On the other hand, the reinforcing bar 114 will be of a length corresponding to its desired finished dimension.

Referring to FIG. 4, the excess material is indicated by the lower shrinkage space 160, that provides an allowance for shrinkage of the unitary patio door assembly frame 102 (FIG.1). The lower shrinkage space 160 has a length L that in a preferred embodiment is approximately 0.5 inches in length. This space 160, and similar spaces at the top and sides, allows for approximately 0.5 inches shrinkage in height at the bottom and 0.5 inches at the top, and 0.5 inches shrinkage on the left side and 0.5 inches shrinkage on the right side. However, it will be appreciated that the amount of shrinkage is dependent on the overall dimensions of the unitary patio door assembly 102 and thus, the amount of excess shrinkage space may vary. However, as the reinforcing bar 114 itself does not shrink, the length of the reinforcing bar 114 is chosen so as to correspond to the finished dimensions of the inner left reinforced sash style 138. This is indicated in FIG. 4 by the fact that the lower edge of the reinforcing bar 114 is displaced from the inwardly facing face of the inner bottom sash rail 140.

As noted, the inner right style 142 is virtually identical to the inner left reinforced sash style 138, and only differs in that there is no channel formed for a reinforcing bar 114. Rather, in the embodiment shown, only the inner left reinforced style 138 is designed to have a reinforcing bar 114. However, while no retention straps 116 are required for holding in a reinforcing bar 114, the inner right sash style 142 is provided with excess plastic material along its inner face which is similar to the retention straps 116. This excess material advantageously serves to provide bumpers or spacers 158 for the insulating glass units 108 when they are installed in the inner frame 112, and also is advantageous aesthetically since the bumpers or spaces 158 have an appearance similar to that of the securing straps 116 for holding the reinforcing bar 114.

After completion of the molding process, the sash rails and sash styles of the unitary patio door assembly frame 102 will uniformly shrink. The length L (see FIG. 4) of the shrinkage space 160 as shown in FIG. 4, as well as the corresponding areas of excess sash material provided in the outer left style 124 (FIG. 3), and the integrally formed inner and outer right styles 128, 142 (FIGS. 3 and 6), as well as in the inner and outer top and bottom sash rails 122, 136, 126, 140 (see FIGS. 3, 4, and 6), will shrink so that the lower edge 161 of the reinforcing bar 114 (see FIG. 4) will preferably contact the top surface of the inner bottom rail 140. Although the gap between the end of the reinforcing bar 114 may not completely disappear after shrinkage, there will be little to no space between the reinforcing bar 114 and the top surface of the inner bottom rail 140. As noted above, in a preferred embodiment of a unitary patio door assembly 102 having a dimension of 6 feet wide by 6 foot 8 high, the amount of shrinkage along the horizontal sash rails and vertical sash styles is approximately 0.5 inch at each end, or 1 inch in total.

Once the unitary patio door assembly frame 102 (FIG. 1) is molded and shrinkage has occurred, the insulated glass unit 108 for the fixed door frame can be installed. The fixed inner frame 112 (FIGS. 3 and 4) houses the insulated glass unit 108 (see FIG. 1), which is installed after the unitary patio door assembly frame 102 is completely molded, and shrinkage has occurred. Once the insulated glass unit 108 is installed, the resulting product is a fixed patio door that sits within the unitary patio door assembly frame 102. The fixed inner frame 112 (FIGS. 3 and 4) separates the unitary patio door assembly frame (FIG. 1) 102 into two halves, the right half comprising the fixed patio door, and the left half being open, but able to receive a second movable patio door.

Referring to FIG. 7, there is shown a portion of the inner left reinforced style 138 of the patio door assembly 100 (FIG. 1) having an insulated glass unit 108 installed therein. As can be seen, the inner left style 138 has an integral reinforcing bar 114 therein, which is retained in place by retention straps 116 (one of which is partially shown in FIG. 7). The insulated glass unit 108 is comprised of a first glass pane 108a and a second glass pane 108b that is separated by a glass pane spacer 156. To assemble the glass unit 108 into the fixed inner frame 112, the insulated glass unit 108 is placed against the left support ledge or lip 146 (FIG. 7; see also FIG.4), and against support ledges or lips 144, 150 and 148 (see FIGS. 3, 4, and 6) of the other sash rails 136, 140 and sash style 142, respectively. Adhesives may be used to secure the insulated glass unit 108 within the fixed inner frame 112. Additionally, referring to FIG. 7, a sealant material 157 is added to insure proper sealing of the insulated glass unit 108 in the fixed door frame 112. A glazing bead 154 is then inserted into the glazing bead slot 152 to help secure the insulated glass unit 108 in place.

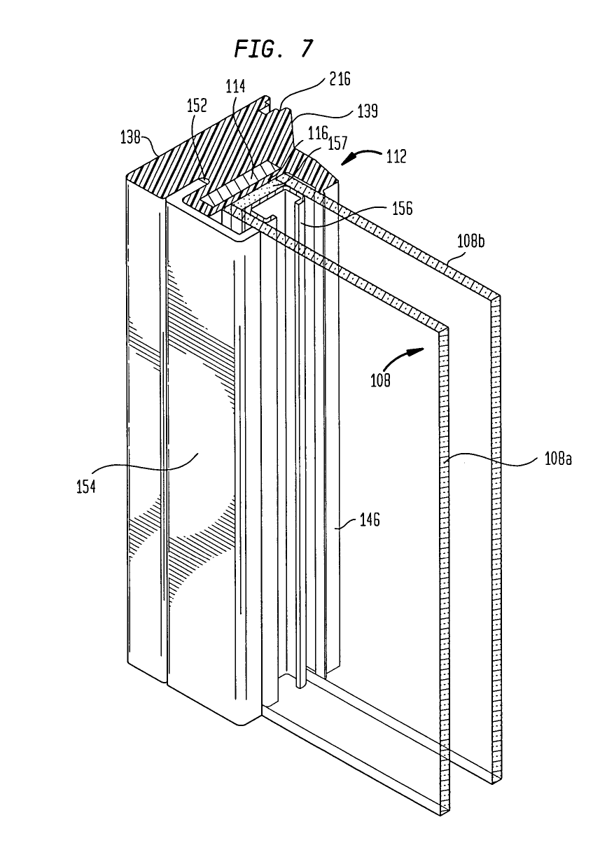

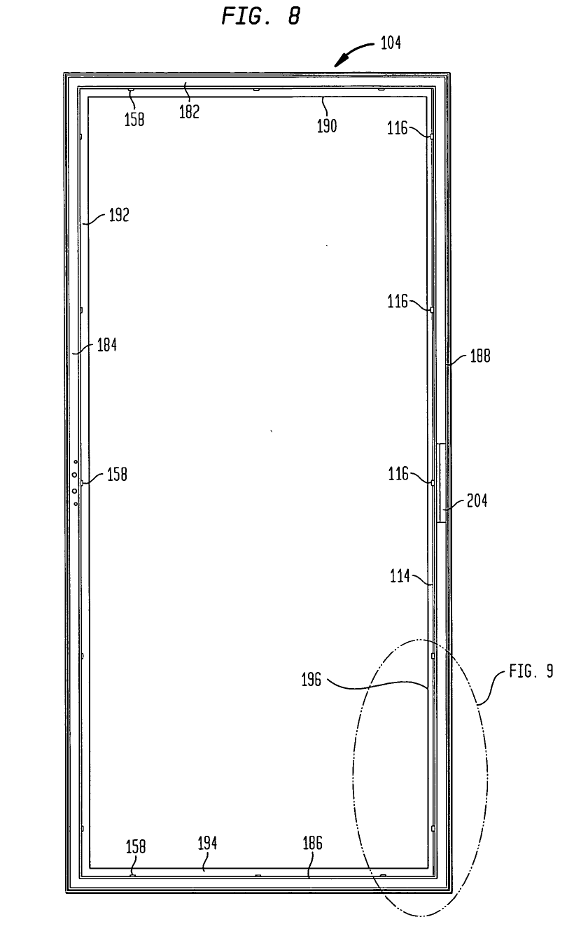

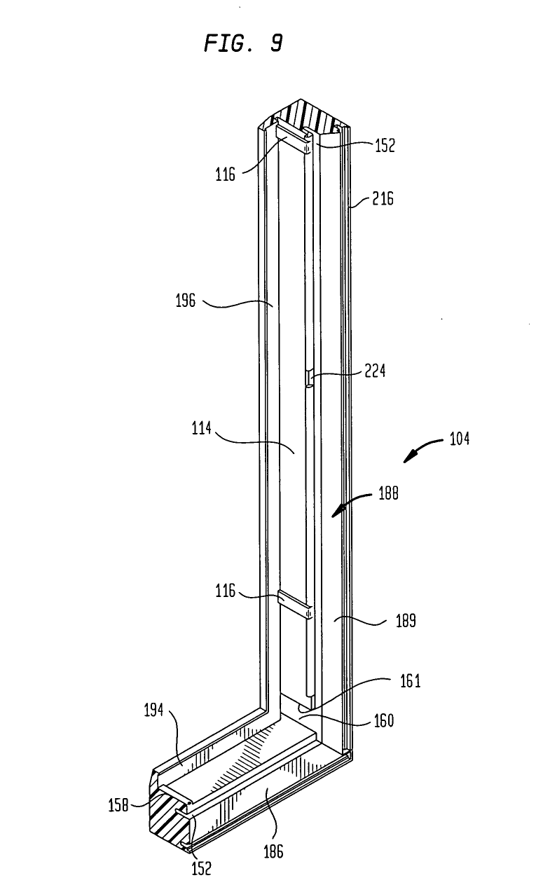

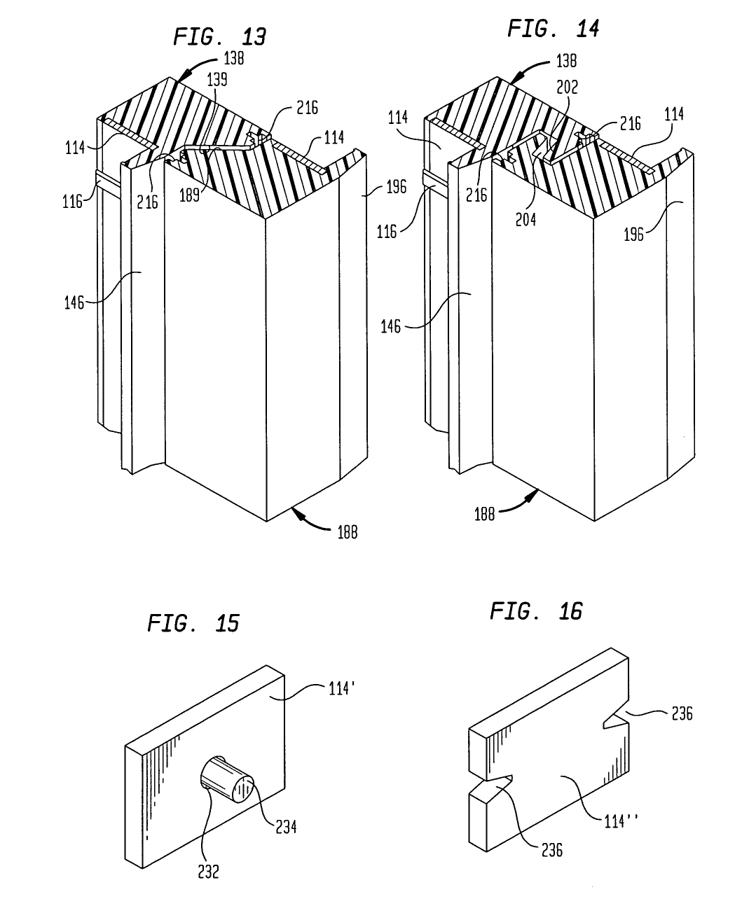

Turning to the second primary component of the patio door assembly 100 (FIG. 1) in accordance with the present invention, the movable patio door frame 104 is shown in FIG. 1, as viewed from the inside, and in FIG. 8, as viewed from the outside. The movable patio door frame 104 is designed to be installed into the unitary patio door assembly frame 102 (see FIG. 1). Referring to FIG. 8, the movable patio door frame 104 comprises an insert top sash rail 182, an insert left sash style 184, an insert bottom sash rail 186 and an insert right sash style 188. There is also an insert top ledge or lip 190, an insert left ledge or lip 192, an insert bottom ledge or lip 194, and an insert right ledge or lip 196, all of which are used to support an insulated glass unit 108 (not shown). Referring to FIG. 9, a portion of the insert right sash style 188 and insert bottom sash rail 186 is shown. The insert right sash style 188 is the sash member that is reinforced with an integral reinforcing bar 114. When the moveable patio door frame 104 is assembled into the unitary patio door assembly frame 102 (see FIGS. 2 and 3), and in its closed position, the insert right sash style 188 (FIGS. 8 and 9) of the moveable patio door frame 104 and the inner left reinforced sash style 138 (FIGS. 2, 3, and 4) of the unitary patio door assembly frame 102 will be adjacent to one another, and will be located approximately at the vertical centerline of the unitary patio door assembly 102. This is the location that requires the most reinforcement to withstand wind loads or other structural loading. Thus, in accordance with a preferred embodiment, the two adjacent sash styles 138 (FIGS. 3 and 4), 188 (FIGS. 8 and 9) are both formed with integral reinforcing bars 114. Further, as discussed more fully hereinbelow, the mating faces of the two adjacent sash styles 138, 188 also are each formed to have raised sloping surfaces 139, 189 (see FIGS. 4 and 9 and 10-13) and an interlock member 202, 204 (see FIGS. 1, 8 and 10-14) for holding the mating sash styles 138, 188 together, particularly in the event of high wind loads. The mating faces of the sash styles 138, 188 are also provided with T-shaped grooves 216 (see FIGS. 4, and 9-14) for receipt of wool pile seals (not shown) which will seal against the face of the opposite sash style when the two sash styles 138, 188 are in mating relationship. (See, for example, FIGS. 13 and 14.)

The movable patio door assembly frame 104 (FIGS. 1, and 8-9) is virtually identical to the fixed inner frame 112 (see FIG. 2), except that the right vertical sash style 188 is reinforced in the moveable patio door frame 104, and not the left inner sash style as in the fixed inner frame 112. Also, the movable patio door assembly frame 104 is not fixed within an outer frame, and is therefore free to move within the unitary patio door assembly frame 102 when the movable patio door assembly frame 104 is installed therein (see FIG. 1). In this regard, the movable patio door assembly frame 104 is designed to slide within the patio door channel 130 (see FIG. 4), and also to be removable from the unitary patio door assembly frame 102 (see FIG. 1). In terms of the reinforced sash style 188 (see FIGS. 8 and 9), the reinforcing bar 114 is integrally molded with the injection molding of the moveable patio door frame 104, with the plastic material encasing the reinforcing bar 114 on three sides (i.e., one of the flat wide surfaces and the two edge surfaces) and with integral retention members or straps 116 extending across the exposed surface of the reinforcing bar 114 and also integrally formed with the plastic sash style 188 at the same time as formation of the overall moveable patio door frame 104. As with the reinforced sash style 138 in the fixed inner frame 112 (see FIGS. 2-4), the lower edge of the reinforcing bar 114 is spaced from the surface of the horizontal sash rail 186 (see FIG. 9) at the time of formation in order to allow for and accommodate shrinkage. Again, as with the fixed inner frame 112 (see FIG. 4), the amount of shrinkage in a preferred embodiment is on the order of 0.5 inch at each end of the sash style 188 (see FIG. 9), or a total of 1.0 inch, so that the lower edge of the reinforcing bar 161 is spaced approximately 0.5 inch from the upper face of the lower horizontal sash rail 186 (and 0.5 inch from the lower face of the upper sash rail 184 (not shown)). Also, as with the fixed inner frame 112, the number of securing members or straps 116 on the moveable patio door frame 104 (see FIG. 8) in a preferred embodiment is five, and they are evenly spaced along the vertical extent of the moveable door frame 104. Further, as with the fixed inner frame 112 (see FIGS. 3 and 4), the mold for making the moveable patio door frame 104 (FIG. 8) is designed to provide integrally molded plastic bumpers or cushions 158 on the top and bottom sash rails 182, 186 (see FIGS. 8-9) and the left vertical sash style 184 for supporting an insulating glass unit 108. One such strap member is shown in FIG. 9.

After shrinkage of the moveable door frame 104 (FIGS. 8-9), an insulated glass unit 108 (not shown) is assembled into the frame 104 in the same fashion and using the same materials as described above; namely, an insulated glass unit 108 is placed against the securing straps 116 and/or bumpers 158, and glazing beads 154 (not shown) are inserted into the glazing bead slots 152.

In another important feature of the present invention, the unitary patio door assembly frame 102 (FIGS. 1-3) is capable of being rotated 180°. In this rotated position, instead of the fixed inner frame 112 being located on the right side, as shown in FIG. 3, the fixed inner frame 112 will be located on the left side. The movable patio door assembly frame 104 can then be placed into the right side of the unitary patio door assembly frame 102 so that it will slide from right to left, instead of left to right. This is an advantageous feature because it allows a purchaser to determine where he or she would prefer to locate the opening of the door, and provides the purchaser with the option of arranging the location of the door opening based upon the anticipated location of furniture and the like in the room, instead of vice versa.

Turning to another important feature of the present invention, and unlike the prior art, as discussed above, the components of the unitary patio door assembly frame 102 are integrally formed with one another. This is possible in accordance with the present invention by virtue of supporting a reinforcing bar 114 (FIG. 2) in a mold used for injection molding and then injection molding plastic around the reinforcing bar 114, with retention members or straps 116, integrally formed to hold the bar in the finished product. Advantageously, in a preferred embodiment the injection molding process is a gas- or liquid-assisted injection molding process.

In accordance with another aspect of the present invention, the injection molding process begins with the creation of a mold for producing a particular desired object which is to be provided with an integral reinforcing bar 114. As is typical, the mold is comprised of two parts which complement one another, so as to form the desired shape and size of the object. This permits removal of the object from the mold once the viscous plastic material has begun to solidify. As is well known in the injection molding art, openings are provided in the mold to permit the introduction of a suitable material of low viscosity, such as a specific type of polymer, into the mold. Once the material is introduced into the mold, the material will begin to fill each of the cavities of the mold, thereby forming the desired shape and size of the object. In accordance with a preferred embodiment, gas or liquid assisted injection molding is utilized to create a reinforced patio door assembly 100 (FIGS. 1-3) having an integral reinforcing bar 114 therein. By this method, high pressure fluid (gas or liquid) is introduced into the mold to push the volume of molten plastic through the cavity of the mold. The volume of plastic used by this method is typically equal to about 70-80% of the volume of the mold. By this method, a hollow is formed in this gas pocket to increase the insulating value for the product and the strength of the cross-section of the frame. Material costs are also typically reduced from 20-25%. Such fluid assist injection molding processes are described, for example, in U.S. Pat. Nos. 4,824,732; 4,923,666; and 5,198,240, each of which is hereby incorporated by reference.

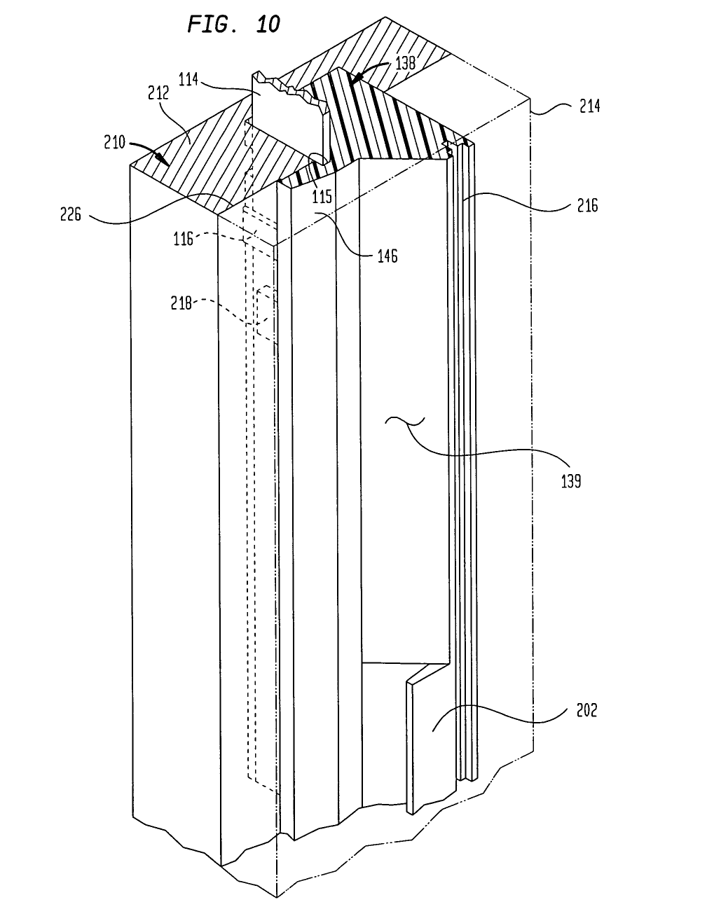

Referring to FIGS. 10-12, the formation of the patio door assembly 100 begins by providing a mold 210 (FIG. 10) of a patio door assembly 100, preferably according to the dimensions and specifications outlined above. In an important feature of the present invention, the patio door assembly 100 is created using two large molds: a first mold 210 to create the unitary patio door assembly frame 102 (FIGS. 1-3), and a second mold (not shown) to create the movable patio door assembly frame 104 (FIGS. 1 and 8) Furthermore, the first and second molds are preferably each created in two halves to allow for the mold to be easily separated after formation of the unitary patio door assembly frame 102 and movable patio door assembly frame 104, respectively.

Preferably, as shown in FIGS. 10-12, the first mold 210 is comprised of two halves 212, 214, which, when placed together, create the shape of the unitary patio door assembly frame 102, preferably according to the disclosure herein. As described above, the first mold 210 will include the shape of the fixed inner frame 112, as well as the outer frame 110 having the patio door channel 130 and screen door channel 132 formed therein (see FIGS. 3, 4 and 6). In this regard, the first mold 210 includes a mold cavity for production of the inner and outer top and bottom sash rails 122, 136 and 126, 140, the outer left and right vertical sash styles 124, 128 and the vertical inner left and right sash styles 138, 142 (the left sash style 138 of which is to be reinforced) (see FIG. 6), all interconnected to provide a unitary patio door assembly frame 102. The mold 210 must also be of suitable size to provide the required excess material to permit shrinkage after the unitary patio door assembly frame 102 is removed from the mold 210.

Turning to FIG. 10, there is shown a perspective and partial cutaway view of a portion of one of the mold halves 212 for forming the inner left reinforced style 138. The already molded portion of the inner left reinforced style 138 is also shown, with the other half 214 of the mold 210 being shown in dashed outline. The first half 212 of the mold includes the shape for forming the outside facing half of the inner left reinforcing sash style 138, i.e., the part of the sash style shown in FIG. 4 having the glazing bead slot 152 and the major portions of the retention or securing straps 116. The other half 214 of the mold 210 includes the shape for forming the inside facing half of the inner left reinforcing sash style 138, having the left support ledge or lip 146 and also having a groove 115 for receipt of the reinforcing bar 114 as well as a suitable recess for formation of the integral retention strap 116 (shown in dotted outline). The mold half 214 also includes the shape for forming the T-groove 216 for receipt of a wool pile seal (not shown).

As noted above, in accordance with one aspect of the present invention, the reinforcing bar 114 is to be placed in the cavity of the mold 210 so that the injection moldable plastic material may flow into the cavity and surround and hold the reinforcing bar 114 in place. As will be appreciated, the reinforcing bar 114 must be placed in the mold cavity before the injection molded material is introduced in order that the reinforcing bar 114 will be integrally formed in the injection molded part. The reinforcing bar 114 cannot simply be placed into the bottom of the mold cavity, but instead must be partially hung in the space to allow for the formation of the various sash rails and styles and allow for plastic shrinkage top and bottom.

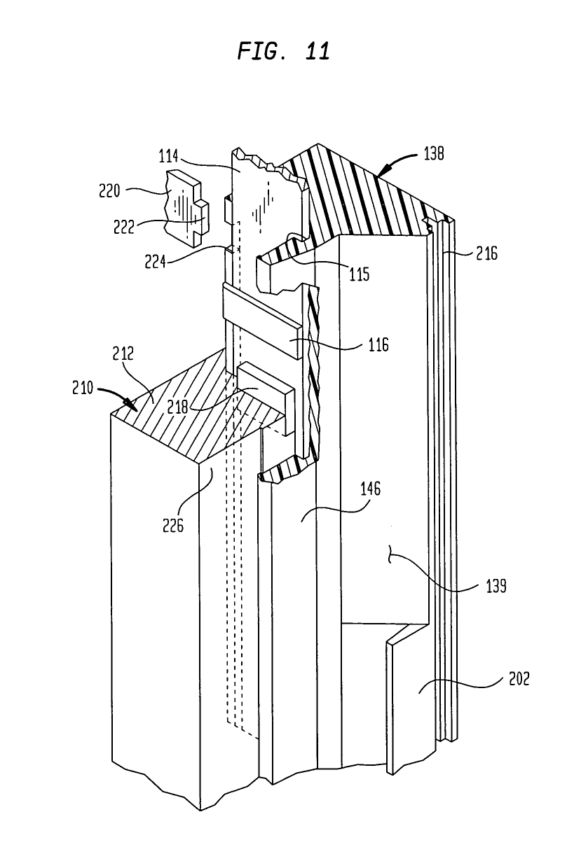

In accordance with a preferred embodiment, as shown in FIGS. 10-12, the reinforcing bar 114 is held in place in the mold cavity by using one or more electromagnets 218 which are provided in one of the mold halves 212. One such electromagnet 218 is illustrated in FIG. 11, which is similar to FIG. 10 but has been cut away in portions to illustrate the sash style 138 as well as the interior of the first half 212 of the mold 210 in order to show how the reinforcing bar 114 is positioned and held in place. As best seen in FIG. 11, the electromagnet 218 is supported in the first mold half 212 so that one face thereof will lie along the edge of the mold so as to be flush therewith (or to extend slightly therebeyond). This will thus define the location of the surface of the exposed face of the reinforcing bar 114 in the completed unitary patio door assembly frame 102. Once the reinforcing bar 114 is placed in the desired position against the electromagnet 218, the electromagnet 218 can then be activated to hold the reinforcing bar 114 in position in the mold cavity.

Referring to FIG. 11, the mold 210 utilized for creating the reinforced patio door assembly 102 also preferably includes a positioning mechanism for properly positioning the reinforcing bar 114 relative to the mold half 212 before the electromagnet 218 or other holding mechanism is activated. In the preferred embodiment, that positioning mechanism comprises a plurality of spaced locater stops 220 in the first mold half 212 which serve to provide a physical indication as to where to locate the reinforcing bar 114 once it is positioned inside the mold 210. As is best shown in FIG. 11, the locater stops 220 include a protruding lip 222 which extends out of the body of the mold half 212 into the cavity. The protruding lips 222 are designed to be contacted by the edge of the reinforcing bar 114, so that the locater stops 220 serve to position the reinforcing bar 114 in the front-to-back direction. Only one such stop 220 is shown in FIG. 11, but preferably there are a plurality of such locater stops 220 along what will become the vertical height of the inner sash style 138. A similar stop or pin may be provided in the lower end of the mold cavity for locating the bottom edge 161 of the reinforcing bar 114 (FIGS. 4 and 9).

Advantageously, in accordance with a further preferred embodiment, a robot may be provided for picking up the reinforcing bar 114 and positioning the reinforcing bar 114 within the mold cavity. The robot may be programmed to pick up the reinforcing bar 114 from a supply and then to move the reinforcing bar 114 into the cavity of the mold 210 until it contacts the locator stops 220 located in the mold half 212. The locator stops 220 thus provide a physical indication as to where to locate the reinforcing bar 114 once it is positioned inside the mold 210. It is an important feature of the present invention that the robot handling the steel bar 114 can be programmed to stop movement of the reinforcing bar 114 once it has made contact with the locator stops 220, instead of preprogramming the robot to move precalculated distances within the mold 210 to position the reinforcing bar 114. Typically, there are three to five locator stops 220 provided within the molds, although only one stop 220 is necessary to provide an indicator as to where the steel bar 114 is positioned. As best seen in FIG. 11, the locator stops 220 are adjacent to the inner left reinforced style 138, and therefore create notches 224 along the inner face on the sash style 138 when the mold 210 is removed (see FIG. 4 for the unitary patio door assembly frame 102, and FIG. 9 for the moveable patio door frame 104). Alternatively, if a robot is used for positioning the reinforcing bar 114, the physical position of the lower end of the reinforcing bar 114 can be determined by movement of the robot vis-à-vis a known reference point on the frame. Referring to FIG. 11, once the robot positions the reinforcing bar 114 within the appropriate location on the inner left reinforced style 138, the electromagnet or magnets 218 are activated and the robot releases the reinforcing bar 114.

The reinforcing bar 114 is then securely held in place throughout the remainder of the molding process. Placing the reinforcing bar 114 within the mold 210 during the molding process is an important feature of the present invention. In addition to providing a reinforced injection molded plastic patio door assembly, it also reduces the amount of materials and overall time needed to separately manufacture the reinforced sash members 138, 188 (FIGS. 4 and 9) of the unitary patio door assembly frame 102 and movable patio door assembly frame 104 and then place the reinforcing bar 114 within the appropriate sash styles 138, 188.

The important feature of the present invention is the integral molding of the retention member or straps 116 about the reinforcing bar 114. In the preferred embodiment, and referring to FIGS. 10-12, the first mold half 212 is provided with suitable recesses in the shape of the retention members 116 adjacent the surface of the first mold half 212 against which the reinforcing steel bar 114 is to be positioned to allow the introduction of injection moldable plastic material in order to integrally mold the retention straps or members 116 around the reinforcing bar 114. In this regard, the mold parting line 226 is shown in FIG. 10, and extends through a portion of the steel reinforcing bar 114 and against the support surface of the inner support ledge or lip 146. Because of the recesses provided for the retention straps 116, the first mold half 212 can be simply withdrawn after the injection moldable plastic material has solidified, leaving the integrally formed securing straps 116 in place together with the integral reinforcing bar 114.

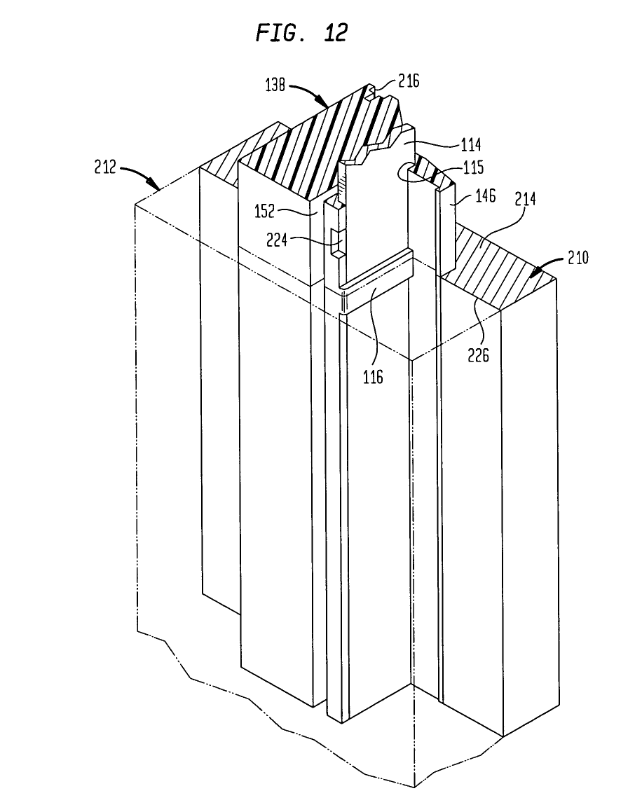

Once the reinforcing bar 114 is secured within the first mold half 212, the second half 214 of the mold 210 is joined with the first half 212 of the mold 210. The second half 214 of the mold 210 is shown in FIG. 12 but from the opposite side to that shown in FIGS. 10 and 11. Thereafter, the material selected to comprise the patio door assembly 100 is injected into the mold 210. In a preferred embodiment, the patio door assembly 100 is comprised of polypropylene. It should be appreciated, however, that other materials capable of being molded into a frame may be used to construct the patio door, such as polyethylene or polyvinyl chloride (PVC).

The polypropylene is injected at high temperatures, typically on the order of 300-400° F. The high temperatures help to maintain the viscous proprieties of the polypropylene which allow the polypropylene to infiltrate the cavities of the first and second halves 212, 214 of the molds 210. Once the polypropylene is injected into the mold 210, gas or liquid may then be injected into the mold 210 to push the volume of molten plastic through the cavity of the mold. As noted above, the volume of plastic used in this method is equal to about 70-80% of the volume of the mold. By this method, a hollow is formed by the gas pocket which serves to increase the insulating volume and the strength of the cross-section of the frame, as well as reduce material costs by 20-25%.

Once the gas or liquid has been added to the mold cavity, the cavity of the mold 210 is allowed to cool until a hardened exterior shell of the unitary patio door assembly frame 102 is formed. In order to assist in the cooling process, the mold 210 may be surrounded or sprayed by cold water. It typically takes from 5-15 minutes to cool the mold 210 down to a sufficient temperature to allow the unitary patio door assembly frame 102 to be removed from the mold. Once an appropriate temperature is reached, and it is determined that a hardened exterior shell of the unitary patio door assembly frame 102 has developed, the mold halves 212, 214 are removed.

As shown in FIG. 12, the retention straps 116 and notches 224 become apparent upon removal of the first half 212 of the mold 210. (See also FIG. 4 for the unitary patio door assembly frame 102, and FIG. 9 for the moveable patio door frame 104). At this time, the reinforcing straps 116 and overall unitary patio door assembly 102 are solidified and able to retain the reinforcing bar 114 within the sash style 138. Once the mold halves 212, 214 are removed, the fixed unitary patio door assembly frame 102 immediately begins to shrink. It will shrink approximately 0.5 inches at each end, or 1 inch both vertically and horizontally, when the mold halves 212, 214 are released and the unitary patio door assembly frame 102 continues to cool and harden. It will take approximately 1-3 hours for the unitary patio door assembly frame 102 to shrink down to the final and desired size. Each of the sash rails and sash styles of the unitary patio door assembly frame 102 will uniformly shrink. As shown in FIG. 5, the overall unitary patio door assembly frame 102 will decrease in size from the initial molded portion 170 formed by the mold 210, to the shrinkage size 172, i.e., the final desired size of the unitary patio door assembly frame 102. As noted, in a preferred embodiment, the sash rails and styles will each decrease in length by about 1.0 inch.

In the embodiment shown with reference to FIGS. 10-12, the inner left reinforced sash style 138 is also provided with an integral interlock member 202 on the inside facing surface of the sash style 138 which is adapted to interlock and mate with a similar interlock member 204 provided on the outside facing surface of the sash style 188 of the moveable door frame 104 (see FIG. 9). The two interlock members 202, 204, only one of which is shown in FIGS. 10 and 11, need only extend approximately 8 inches in length, and are adapted to interlock with one another when the moveable door frame 104 is in its closed position relative to the patio door assembly frame 102. As shown in FIG. 14, when interlocked, the two reinforced sash styles 138, 188—one (138) on the fixed door frame 102 and one (188) on the moveable door frame 104 are interlocked together to thereby increase the strength and stability of the overall unitary patio door assembly 100. The interlocked vertical sashes 138, 188 thus are held together to provide increased strength when the moveable door frame 104 is in its closed position.

The interlock members 202, 204 may be integrally molded with the remaining portion of the frames 102, 104 through the use of a cam activated slide member provided in the mold 210 which is adapted to be slid into position before introduction of the injection molded material to form the inclined surface adjacent the top and bottom of the interlock member 202. In essence, the cam-activated slide member simply serves to insure that a void space is provided for receiving the interlock member 204 on the mating sash style 188. This, for example, may be seen in FIG. 14. Then, after the initial curing of the mold material, the cam-activated slide is retracted into the mold half 214 so as to clear the edge of the interlock member 202 and the mold half 214 then removed. In this regard, the mating faces of the reinforced sash styles 138, 188 have raised, sloping surfaces 139, 189 above and below the interlock members 202, 204. These raised, sloping surfaces 139, 188 serve to provide sufficient depth for the sash styles 138, 188 for forming the interlock members 202, 204 by means of cam activated slide members. As seen in FIG. 13, the sloping surfaces 139, 189 on the adjacent sash styles 138, 188 will mate with one another when the moveable door frame 104 is in its closed position relative to the fixed door frame 102.

It should be appreciated that the integral molding of the reinforcing bar 114 within the mold 210 can be accomplished in alternative ways. As shown in FIG. 15, the reinforcing bar 114′ may have a series of punched holes 232 along its length. The mold could then have a retractable pin or a post 234 within the mold, which could be extended to fit into the hole 232 found on the reinforcing bar 114′. When the mold 210 is ready to be removed, the retractable pin 234 could be retracted into the mold 210, and then the mold 210 removed from the newly formed object.

As shown in FIG. 16, the reinforcing bar 114″ may instead be provided with pre-punched openings 236. The mold 210 in this instance would have corresponding posts that can be extended to fit into the pre-punched openings 236. This will provide another way in which to support the reinforcing bar 114″.

It should be further appreciated that the concept of integrally molding a reinforcement member 114 directly into an object is not limited to the patio door art. The concept can be broadly expanded to encompass many different objects which require reinforcement.

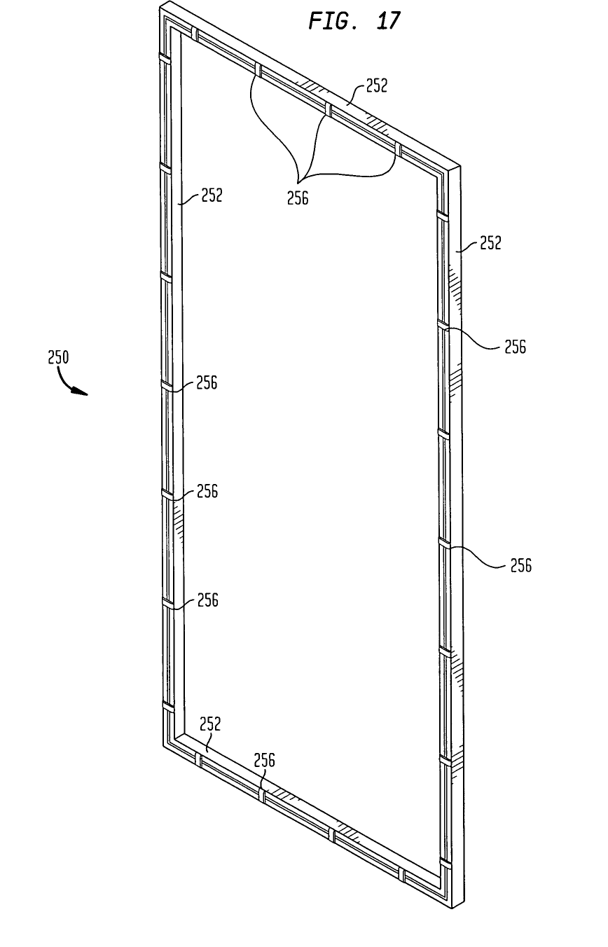

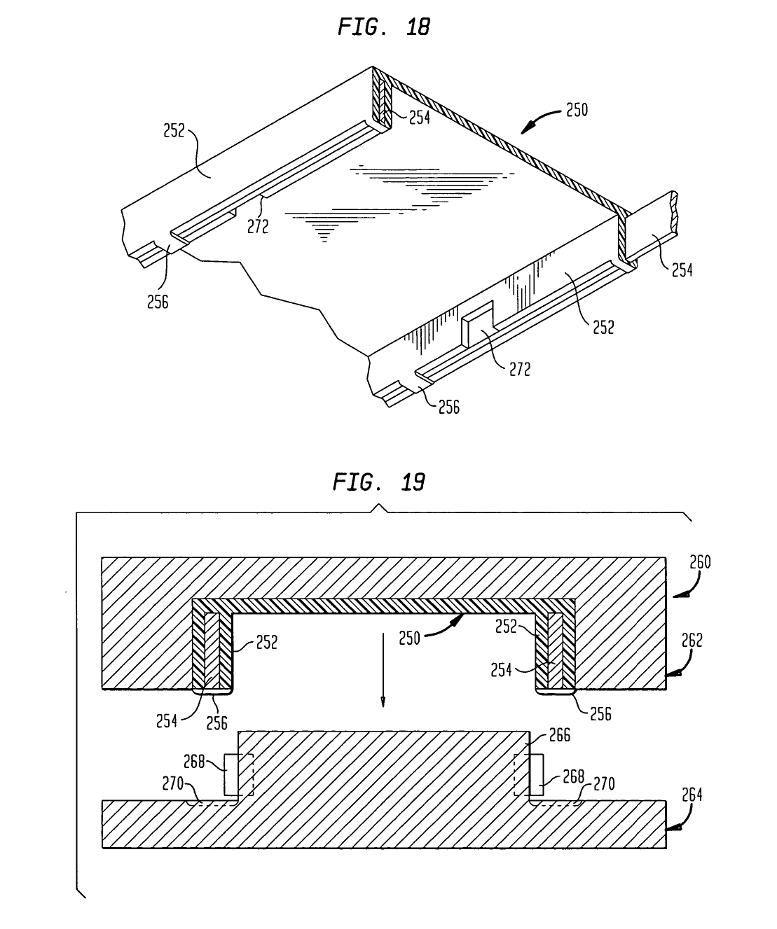

For instance, referring to FIGS. 17-19, there is shown a reinforced table top 250, together with the mold 260 which may be used to produce same. The reinforced table top 250 includes a depending lip 252 extending around the periphery thereof and containing an integral reinforcing bar 254 therewithin. As shown in FIGS. 17 and 18, each of the integral reinforcing bars 254 is integrally received within the depending lip 252 on the table 250, with the plastic surrounding each of the long sides and one of the edges, and with integral securing or retention straps 256 extending at spaced intervals about the bottom edge of the lip 252.

A mold 260 that could be used for producing the reinforced table 250 is shown schematically in FIG. 19. The mold 260 includes two mold halves 262, 264. The lower mold half 264 includes a raised plateau 266 having magnets 268 extending outwardly therefrom for holding the reinforcing bars 254 prior to introduction of the molded plastic. When the two molds 262, 264 are together, with the reinforcing bars 254 held by the magnets 268, viscous plastic material is injected into the mold cavity formed between the two mold halves 262, 264, and forms around the two sides and one end of the respective reinforcing bars 254. By virtue of small recesses 270 provided in the lower mold half 264, the viscous material also is introduced to form securing members or straps 256 around the other edge of the reinforcing bars 254 around the periphery of the table 250. Upon cooling, the reinforced table structure 250 is produced having the integral reinforcing bars 254 therein with securing members or straps 256 provided along the bottom edge of the lip 252 to hold the reinforcing bars 254 in place. In this regard, on the inside of the lip 252 of the table 250, recesses 272 are provided at the locations of the magnets 268 (see FIG. 18). By virtue of the location of the magnets 268 at the lower edge of the lip 252, the lower mold 264 can simply be withdrawn without having to move the magnets 268 into the interior of the mold 264.

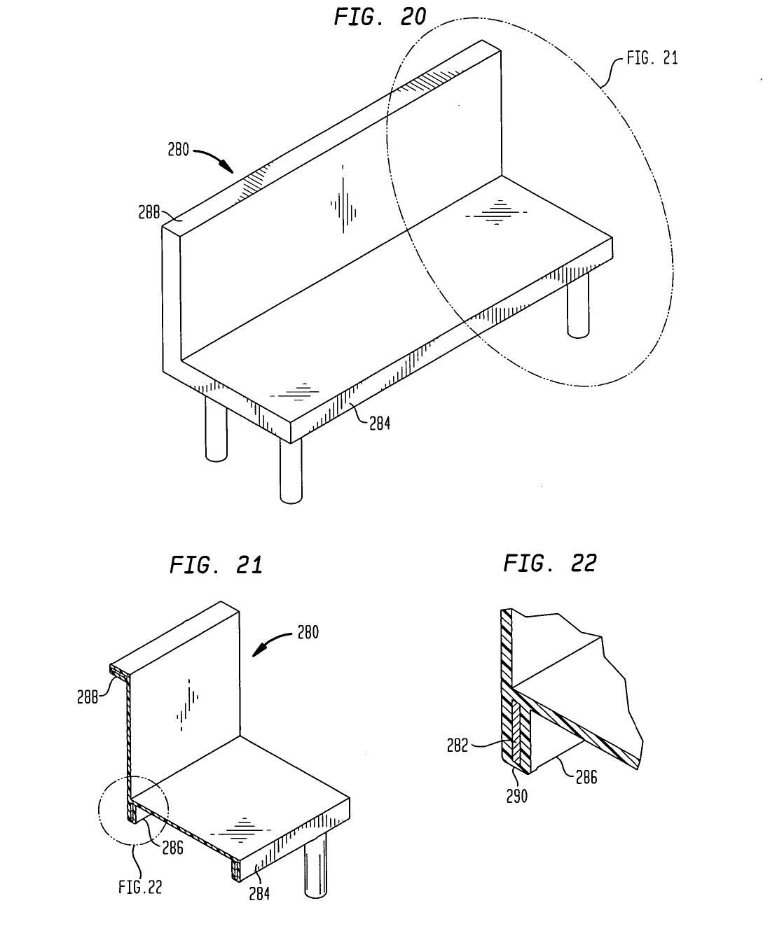

FIGS. 20-22 show an example of a reinforced bench structure 280 having integral reinforcing bars 282 provided therein along the front and bottom edges as well as the rear top edge of the back. As with the reinforced table structure 250, the reinforcing bars 282 are provided in the depending lip portions 284, 286 at the front and back edges and in the rearwardly extending lip 288 on the back of the bench 280. Again, the injection molded plastic surrounds the opposite sides of the reinforcing bar 282 and one edge, with integral retention members or straps 290 being integrally formed about the other edge of the reinforcing bar 282 at spaced locations along the product.

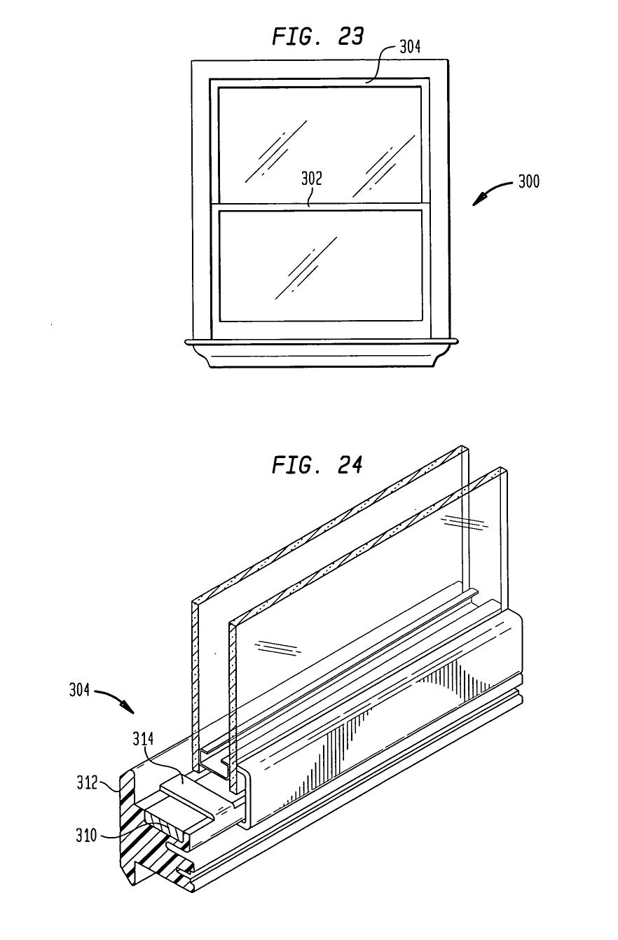

Referring to FIG. 23, a double hung window assembly 300 is shown having an integral reinforcing bar 310 provided in the meet rails 312 of the windows sashes 302, 304 to provide structural reinforcement. The two window sashes 302, 304 of the double hung window assembly 300 each have sash rails or meet rails 312 that are adjacent to one another when the double hung window assembly 300 is in a closed position (see FIG. 23). FIG. 24 shows a portion of the meet rail 312 for the upper window sash 304. The meet rail 312 has an integral reinforcing bar 310 along its length, with a series of integral retention straps 314 serving to hold the reinforcing bar 310 in place. The meet rail 312 of the window sash 304 is very similar to the reinforced sash styles 138 of the patio door assembly frame 102 shown in FIG. 7, and the window sash 304 is created in a similar manner using a mold in the shape of a window assembly. The lower window sash 302 may also be reinforced in a similar manner.

Accordingly, the present invention provides integrally reinforced plastic molded components and products, such as patio door assemblies 100, and more particularly, integrally reinforced molded plastic components and products having integrally molded retention straps 116, 256, 290, 314 for holding a reinforcing bar 114, 254, 282, 310 within the component or product. Although the present invention has been described mainly with reference to a patio door assembly 100, examples of other integrally reinforced plastic molded products are also disclosed, such as a reinforced table 250, a reinforced bench 280, and a reinforced window assembly 300. In accordance with the present invention, the reinforcing bar 114, 254, 282, 310 is integrally formed with the plastic molded component or product, with integrally molded retention straps or members 116, 256, 290, 314 being provided for holding the reinforcing bar 114, 254, 282, 310 within the component or product. Also, in accordance with the present invention, there is disclosed a method for making such an integrally reinforced plastic molded component or products using injection molding equipment, such as gas- or liquid-assist injection molding equipment. A mold 210, 260 is provided which has a cavity in the shape and size of the desired object, and also to include integrally connected retention securing straps 116, 256, 290, 314. A reinforcing bar 114, 254, 282, 310 is positioned in the mold and held in place while the plastic material is introduced into the mold cavity to surround a portion of the periphery of the bar 114, 254, 282, 310. The retention straps 116, 256, 290, 314 are arranged to close the other portion of the periphery by virtue of being located adjacent the other portion of the periphery of the reinforcing bar 114, 254, 282, 310.

Although the invention herein has been described with reference to particular embodiments and preferred dimensions or ranges of measurements, it is to be understood that these embodiments are merely illustrative of the principles and applications of the present invention. Additionally, it is to be appreciated that the present invention may take on various alternative orientations. It is therefore to be understood that numerous modifications may be made to the illustrative embodiments and that other arrangements may be devised without departing from the spirit and scope of the present invention as defined by the appended claims.

1. A reinforced injection molded plastic product, comprising:
a plastic body comprised of plastic material injection molded into a size and shape corresponding to the size and shape of the product to be reinforced;
a reinforcing member for reinforcing said plastic body, said reinforcing member being arranged so as to be in intimate contact with said plastic material comprising said plastic body about a first portion of said reinforcing member at the time said plastic material is injection molded into said plastic body; and
at least one integral retention member comprised of the same plastic material forming said plastic body and being integrally formed with said plastic material at the time said plastic body is injection molded, said integral retention member being disposed so as to extend about a second portion of said reinforcing member so as to retain said reinforcing member in said plastic body.

2. The reinforced injection molded plastic product of claim 1, wherein said reinforcing member comprises an elongated reinforcing bar for reinforcing such plastic body along a longitudinal dimension of such plastic body, said elongated reinforcing bar being arranged so as to extend along said longitudinal dimension of said plastic body with said plastic material in intimate contact partially about the circumference of said elongated reinforcing bar along substantially the length of said elongated reinforcing bar, and wherein said integral retention member is disposed so as to extend along a portion of the length of said elongated reinforcing bar about the remaining part of the circumference of said reinforcing bar which is not in intimate contact with said plastic material.

3. The reinforced injection molded plastic product of claim 2, wherein said elongated reinforcing bar comprises a flat reinforcing bar having a first side and a second side, said flat reinforcing bar being arranged so that said first side thereof is in intimate contact with said plastic material of said plastic body substantially along the length of said flat reinforcing bar, and wherein said integral retention member extends along a portion of the length of said flat reinforcing bar about said second side of said flat reinforcing bar to form an integral strap arranged to extend across a portion of said second side of said flat reinforcing bar and integral with said plastic material of said plastic body.

4. The reinforced injection molded plastic product of claim 2, wherein said elongated reinforcing bar comprises a flat reinforcing bar having a first flat side, a second flat side, and two edges extending between said first and second flat sides, said first and second flat sides and one of said edges being arranged in intimate contact with said plastic material along substantially the entire length of said flat reinforcing bar, and wherein said integral retention member is arranged to extend across the other of said edges along a portion of the length of said flat reinforcing bar and integral with said plastic material of said plastic body.

5. The reinforced injection molded plastic product of claim 1, wherein said plastic product comprises a unitary door frame in which said plastic body includes two sash styles and two sash rails integrally formed with one another and connected together at the respective ends thereof; wherein said reinforcing member is arranged in one of said sash styles in intimate contact with said plastic material; and wherein said at least one integral retention member is disposed so as to extend along a portion of the length of said reinforcing member across said reinforcing member and is integral with said plastic material of said one sash style.

6. The reinforced injection molded plastic product of claim 1, wherein said plastic product comprises a unitary outer frame for a plastic door assembly in which said plastic body includes four sash members integrally formed and connected together at the respective ends thereof to form the shape of a rectangle, and an intermediate sash member integrally formed with said four sash members and extending between two of said sash members forming said rectangle; wherein said reinforcing member is arranged in said intermediate sash member so as to be in intimate contact with said plastic material; and wherein said retention member is integrally formed with said intermediate sash member and extends across said reinforcing member.

7. The reinforced injection molded plastic product of claim 1, wherein said plastic product comprises a table in which said plastic body includes a table top and a depending lip around the circumference thereof, and wherein said reinforcing member is arranged so as to be disposed in said depending lip.

8. The reinforced injection molded plastic product of claim 7, wherein said table top is rectangular in shape and has a depending lip along each side thereof, and wherein four of said reinforcing members are provided, each of which is arranged in one of said depending lips of said table top.

9. The reinforced injection molded plastic product of claim 1, wherein said plastic product comprises a window in which said plastic body includes two sash rails and two sash styles integrally formed with one another and connected together at the respective ends thereof, and wherein said reinforcing member is arranged to be disposed in one of said sash rails and sash styles.

10. The reinforced injection molded plastic product of claim 9, wherein said reinforcing member is arranged in one of said sash rails.

11. The reinforced injection molded plastic product of claim 9, wherein said window includes a window frame and first and second window units mounted in said window frame, each of said first and second window units comprising a plastic body having two sash rails and two sash styles integrally formed with one another and connected together at the respective ends thereof, and at least said first window unit being mounted in said window frame for movement relative to said second window unit between an open position and a closed position; and wherein said first window unit when in said closed position has one of said sash rails adjacent to one of said sash rails of said second window unit, and wherein said reinforcing member is arranged to be disposed in one of said adjacent sash rails.

12. The reinforced injection molded plastic product of claim 1, wherein said plastic product comprises a bench in which said plastic body includes a seat and a depending lip, and wherein said reinforcing member is arranged to be disposed in said depending lip.

13. The reinforced injection molded plastic product of claim 1, wherein at least a portion of said reinforcing member is visible in said plastic body.

14. A reinforced injection molded plastic product, comprising:
a plastic body comprised of plastic material injection molded into a size and shape corresponding to the size and shape of the product to be reinforced;
an elongated reinforcing member for reinforcing said plastic body along a longitudinal dimension of said plastic body, said reinforcing member being arranged so as to extend along said longitudinal dimension of said plastic body and to be in intimate contact with said plastic material forming said plastic body at the time said plastic material is injection molded into said plastic body so that said plastic material extends partially about the circumference of said reinforcing member along substantially the length of said elongated reinforcing member; and
at least one integral retention member comprised of the same plastic material forming said plastic body and being integrally formed with said plastic material at the time said plastic body is injection molded, said integral retention member being disposed so as to extend along a portion of the length of said reinforcing member about the remaining part of the circumference of said reinforcing member which is not in intimate contact with said plastic material so as to retain said reinforcing member in said plastic body.

15. The reinforced injection molded plastic product of claim 14, wherein said elongated reinforcing member comprises a flat reinforcing bar having a first side and a second side, said flat reinforcing bar being arranged so that said first side thereof is in intimate contact with said plastic material of said plastic body substantially along the length of said flat reinforcing bar, and wherein said integral retention member extends along a portion of the length of said flat reinforcing bar about said second side of said flat reinforcing bar to form an integral strap arranged to extend across a portion of said second side of said flat reinforcing bar and integral with said plastic material of said plastic body.

16. The reinforced injection molded plastic product of claim 14, wherein said elongated reinforcing member comprises a flat reinforcing bar having a first flat side, a second flat side, and two edges extending between said first and second flat sides, said first and second flat sides and one of said edges being arranged in intimate contact with said plastic material along substantially the entire length of said flat reinforcing bar, and wherein said integral retention member is arranged to extend across the other of said edges along a portion of the length of said flat reinforcing bar and integral with said plastic material of said plastic body.

17. The reinforced injection molded plastic product of claim 14, wherein said plastic product comprises a unitary door frame in which said plastic body includes two sash styles and two sash rails integrally formed with one another and connected together at the respective ends thereof; wherein said elongated reinforcing member is arranged in one of said sash styles in intimate contact with said plastic material; and wherein said at least one integral retention member is disposed so as to extend along a portion of the length of said elongated reinforcing member across said elongated reinforcing member and is integral with said plastic material of said one sash style.

18. The reinforced injection molded plastic product of claim 14, wherein said plastic product comprises a unitary outer frame for a plastic door assembly in which said plastic body includes four sash members integrally formed and connected together at the respective ends thereof to form the shape of a rectangle, and an intermediate sash member integrally formed with said four sash members and extending between two of said sash members forming said rectangle; wherein said elongated reinforcing member is arranged in said intermediate sash member so as to be in intimate contact with said plastic material; and wherein said retention member is integrally formed with said intermediate sash member and extends across said elongated reinforcing member.

19. The reinforced injection molded plastic product of claim 14, wherein said plastic product comprises a table in which said plastic body includes a table top and a depending lip around the circumference thereof, and wherein said elongated reinforcing member is arranged so as to be disposed in said depending lip.

20. The reinforced injection molded plastic product of claim 19, wherein said table top is rectangular in shape and has a depending lip along each side thereof, and wherein four of said elongated reinforcing members are provided, each of which is arranged in one of said depending lips of said table top.

21. The reinforced injection molded plastic product of claim 14, wherein said plastic product comprises a window in which said plastic body includes two sash rails and two sash styles integrally formed with one another and connected together at the respective ends thereof, and wherein said elongated reinforcing member is arranged to be disposed in one of said sash rails and sash styles.

22. The reinforced injection molded plastic product of claim 21, wherein said elongated reinforcing member is arranged in one of said sash rails.

23. The reinforced injection molded plastic product of claim 21, wherein said window includes a window frame and first and second window units mounted in said window frame, each of said first and second window units comprising a plastic body having two sash rails and two sash styles integrally formed with one another and connected at the respective ends thereof, and at least said first window unit being mounted in said window frame for movement relative to said second window unit between an open position and a closed position; and wherein said first window unit when in said closed position has one of said sash rails adjacent to one of said sash rails of said second window unit, and wherein said elongated reinforcing member is arranged to be disposed in one of said adjacent sash rails.

24. The reinforced injection molded plastic product of claim 14, wherein said plastic product comprises a bench in which said plastic body includes a seat and a depending lip, and wherein said elongated reinforcing member is arranged to be disposed in said depending lip.

25. The reinforced injection molded plastic product of claim 14, wherein at least a portion of said elongated reinforcing member is visible in said plastic body.

26. A reinforced injection molded plastic product comprising a plastic frame; a flat reinforcing member for reinforcing said plastic frame, said flat reinforcing member having a first flat side and a second flat side, and being integrally formed with said plastic frame so that said first flat side is exposed in said plastic frame and said second flat side is in intimate contact with and hidden by said plastic frame; and an integral securing member, said securing member being integrally formed with said plastic frame and extending across said first flat side of said reinforcing member to secure said flat reinforcing member in said plastic frame.

27. The reinforced injection molded plastic product of claim 26, wherein said plastic frame comprises a unitary door frame in which said plastic frame includes two sash styles and two sash rails integrally formed with one another and connected together at the respective ends thereof; wherein said flat reinforcing member is integrally formed in one of said sash styles so that said first flat side of said reinforcing member is exposed in said one of said sash styles and said second flat side of said reinforcing member is in intimate contact with and hidden by said one of said sash styles; and wherein said securing member is disposed so as to extend along a portion of the length of said reinforcing member across said first flat side of said flat reinforcing member.

28. The reinforced injection molded plastic product of claim 26, wherein said plastic frame comprises a unitary outer frame for a plastic door assembly in which said plastic body includes four sash members integrally formed and connected together at the respective ends thereof to form the shape of a rectangle, and an intermediate sash member integrally formed with said four sash members and extending between two of said sash members forming said rectangle; and wherein said flat reinforcing member is integrally formed in said intermediate sash member so that said first flat side of said flat reinforcing member is exposed in said intermediate sash member and said second flat side of said reinforcing member is in intimate contact with and hidden by said intermediate sash member; and wherein said securing member is integrally formed with said intermediate sash member and extends across said first flat side of said flat reinforcing member.

29. The reinforced injection molded plastic product of claim 26, wherein said plastic frame comprises a window in which said plastic body includes two sash rails and two sash styles integrally formed with one another and connected together at the respective ends thereof; and wherein said flat reinforcing member is integrally formed in one of said sash rails and sash styles so that said first flat side is exposed in said one of said sash rails and sash styles and said second flat side of said flat reinforcing member is in intimate contact with and hidden by said one of said sash rails and sash styles.

30. The reinforced injection molded plastic product of claim 29, wherein said flat reinforcing member is arranged in one of said sash rails.

31. The reinforced injection molded plastic product of claim 29, wherein said window includes a window frame and first and second window units mounted in said window frame, each of said first and second window units comprising a plastic body having two sash rails and two sash styles integrally formed with one another and connected together at the respective ends thereof, and at least said first window unit being mounted in said window frame for movement relative to said second window unit between an open position and a closed position; and wherein said first window unit when in said closed position has one of said sash rails adjacent to one of said sash rails of said second window unit, and wherein said flat reinforcing member is arranged to be disposed in one of said adjacent sash rails.

32. A reinforced injection molded plastic product comprising a plastic frame; a flat reinforcing member for reinforcing said plastic frame, said flat reinforcing member having a first flat side, a second flat side, and two edges extending between said first and second flat sides, and said flat reinforcing member being integrally formed with said plastic frame so that said first and second flat sides and said one of said edges are in intimate contact with and hidden by said plastic frame; and an integral securing member, said securing member being integrally formed with said plastic frame and extending across the other of said edges of said flat reinforcing member to secure said flat reinforcing member in said plastic frame.

33. The reinforced injection molded plastic product of claim 32, wherein said plastic product comprises a table in which said plastic body includes a table top and a depending lip around the circumference thereof, and wherein said flat reinforcing member is arranged so as to be disposed in said depending lip.

34. The reinforced injection molded plastic product of claim 32, wherein said plastic product comprises a bench in which said plastic body includes a seat and a depending lip, and wherein said elongated reinforcing member is arranged to be disposed in said depending lip.

35. A reinforced unitary patio door frame having a plurality of sash members made of plastic material integrally molded and connected to one another, one of said plurality of sash members having a reinforcing bar integrally disposed in said one sash member, and an integral retention member integrally formed with said one sash member, said integral retention member holding said reinforcing bar within said one sash member.

36. The reinforced unitary patio door frame of claim 35, wherein said reinforcing bar comprises an elongated reinforcing bar arranged to extend along a longitudinal dimension of said one sash member and to be in intimate contact with said plastic material of said one sash member partially about the circumference of said elongated reinforcing bar along substantially the length of said elongated reinforcing bar, and wherein said integral retention member is disposed so as to extend along a portion of the length of said elongated reinforcing bar about the remaining part of the circumference of said elongated reinforcing bar which is not in intimate contact with said plastic material.

37. The reinforced unitary patio door frame of claim 36, wherein said elongated reinforcing bar comprises a flat reinforcing bar having a first side and a second side, said flat reinforcing bar being arranged so that said first side thereof is in intimate contact with said plastic material of said one sash member substantially along the length of said flat reinforcing bar, and wherein said integral retention member extends along a portion of the length of said flat reinforcing bar about said second side of said flat reinforcing bar to form an integral strap arranged to extend across a portion of said second side of said flat reinforcing bar and integral with said plastic material of said one sash member.

38. The reinforced unitary patio door frame of claim 35, wherein said plurality of sash members comprises four sash members integrally formed and connected together at the respective ends thereof to form the shape of a rectangle, and an intermediate sash member integrally formed with said four sash members and extending between two of said sash members forming said rectangle; wherein said reinforcing bar is integrally formed in said intermediate sash member so as to be in intimate contact with said plastic material of said intermediate sash member; and wherein said retention member is integrally formed with said intermediate sash member and extends across said reinforcing bar.

39. The reinforced unitary patio door frame of claim 35, wherein a plurality of integral retention members are provided integrally formed with said one sash member.

40. The reinforced unitary patio door frame of claim 39, further including a window unit disposed within said integrally molded and connected sash members, and wherein said window unit is supported at least in part by said plurality of integral retention members provided on said one sash member.

41. The reinforced unitary patio door frame of claim 35, wherein at least a portion of said reinforcing bar is visible in said one sash member.

42. A reinforced unitary door frame comprising:
two sash styles and two sash rails integrally formed with one another and connected together at their respective ends, said sash styles and sash rails being made of plastic material injection molded into said sash styles and sash rails;
one of said sash styles having an integral reinforcing bar therein, said reinforcing bar being arranged so as to be in intimate contact with said injection molded plastic material about a first portion of said reinforcing member; and
a raised sash strap integrally formed with said one sash style and arranged to extend across a second portion of said reinforcing bar so as to retain said reinforcing bar in said one sash style.

43. The reinforced unitary door frame of claim 42, wherein said reinforcing bar comprises an elongated reinforcing bar for reinforcing a longitudinal dimension of said one sash slope, said elongated reinforcing bar being arranged so as to extend along said longitudinal dimension of said one sash style and to be in intimate contact with said plastic material partially about the circumference of said elongated reinforcing bar along substantially the length of said elongated reinforcing bar, and wherein said raised strap is disposed so as to extend along a portion of the length of said elongated reinforcing bar about the remaining part of the circumference of said elongated reinforcing bar which is not in intimate contact with said plastic material.

44. The reinforced unitary door frame of claim 43, wherein said elongated reinforcing bar comprises a flat reinforcing bar having a first side and a second side, said flat reinforcing bar being arranged so that said first side thereof is in intimate contact with said one sash style substantially along the length of said flat reinforcing bar, and wherein said raised sash strap extends along a portion of the length of said flat reinforcing bar about said second side of said flat reinforcing bar to form an integral strap with said plastic material arranged to extend across a portion of said second side of said flat reinforcing bar and integral with said plastic material of said one sash style.

45. The reinforced unitary door frame of claim 42, wherein a plurality of raised sash straps are provided integrally formed with said one sash style.

46. The reinforced unitary door frame of claim 45, further including a window unit disposed within said integrally molded and connected sash styles and sash rails, and wherein said window unit is supported at least in part by said plurality of raised sash straps provided on said one sash style.

47. The reinforced unitary door frame of claim 42, wherein at least a portion of said reinforcing bar is visible in said one sash style.

48. A unitary outer frame for a patio door assembly comprising four sash members made of injection molded plastic material and integrally formed and connected together at their respective ends to form the shape of a rectangle, and an intermediate sash member made of injection molded plastic material and integrally formed with said four sash members and extending between two of said sash members forming said rectangle, said intermediate sash member having an integral reinforcing bar therein and a securing strap member integrally formed with said intermediate sash member, said reinforcing bar being arranged so as to be in intimate contact with said intermediate sash member, and said securing strap being integrally formed with said intermediate sash member and extending across said reinforcing bar to secure said reinforcing bar in place in said intermediate sash member.

49. The unitary outer frame for a patio door assembly of claim 48, wherein said reinforcing bar comprises an elongated reinforcing bar for reinforcing a longitudinal dimension of said intermediate sash member, said elongated reinforcing bar being arranged to extend along said longitudinal dimension of said intermediate sash member and to be in intimate contact with said plastic material partially about the circumference of said elongated reinforcing bar along substantially the length of said elongated reinforcing bar, and wherein said securing strap member is disposed so as to extend along a portion of the length of said elongated reinforcing bar about the remaining part of the circumference of said elongated reinforcing bar which is not in intimate contact with said plastic material.

50. The unitary outer frame for a patio door assembly of claim 49, wherein said elongated reinforcing bar comprises a flat reinforcing bar having a first side and a second side, said flat reinforcing bar being arranged so that said first side thereof is in intimate contact with the plastic material of said intermediate sash member substantially along the length of said flat reinforcing bar, and wherein said securing strap member extends along a portion of the length of said flat reinforcing bar about said second side of said flat reinforcing bar to form an integral strap arranged to extend across a portion of said second side of said flat reinforcing bar and integral with said plastic material of such intermediate sash member.

51. The unitary outer frame for a patio door assembly of claim 48, wherein a plurality of securing strap members are provided integrally formed with said intermediate sash member.

52. The unitary outer frame for a patio door assembly of claim 51, further including a window unit disposed within said integrally molded and connected sash members, and wherein said window unit is supported at least in part by said plurality of securing strap members provided on said intermediate sash member.

53. The unitary outer frame for a patio door assembly of claim 48, wherein at least a portion of said reinforcing bar is visible in said intermediate sash member.

54. A patio door assembly comprising:
a fixed outer reinforced patio door frame and a movable inner reinforced patio door frame;
said fixed outer reinforced patio door frame comprising four outer members made of injection molded plastic material and integrally molded and connected to one another at their respective ends to form the shape of a rectangle, and an intermediate member made of injection molded plastic material and integrally molded and connected to said four outer members, said intermediate member having a first integral reinforcing bar therein and a securing strap integrally formed with said intermediate member, said first reinforcing bar being arranged to be in intimate contact with said intermediate member, and said securing strap being arranged to extend across said first reinforcing bar to hold said first reinforcing bar in said intermediate member; and
said movable inner reinforced patio door frame constructed and arranged to fit within said fixed outer reinforced door frame for movement therein, said movable inner reinforced patio door frame having a plurality of inner sash members made of injection molded plastic material and integrally molded and connected together at their respective ends to form the shape of a rectangle, and one of said plurality of inner sash members having a second integral reinforcing bar therein, said second reinforcing bar being arranged to be in intimate contact with said one inner sash member, and an integral sash strap integrally formed with said one inner sash member and arranged to extend across said second reinforcing bar in a manner so as to retain said second reinforcing bar in said one inner sash member.

55. The patio door assembly of claim 54, wherein said first and second reinforcing bars comprise first and second elongated reinforcing bars, said first elongated reinforcing bar being arranged to extend along a longitudinal dimension of said intermediate member in intimate contact with the injection molded plastic material thereof partially about the circumference of said first elongated reinforcing bar along substantially the length of said first elongated reinforcing bar, and said second elongated reinforcing bar being arranged to extend along a longitudinal dimension of said one inner sash member and to be in intimate contact with the plastic material thereof partially about the circumference of said second elongated reinforcing bar along substantially the length of said second elongated reinforcing bar; and wherein said securing strap is disposed so as to extend along a portion of the length of said first elongated reinforcing bar about the remaining part of the circumference of said first elongated reinforcing bar which is not in intimate contact with said plastic material of said intermediate member, and said integral sash strap is disposed so as to extend along a portion of the length of said second elongated reinforcing bar about the remaining part of the circumference of said second reinforcing bar which is not in intimate contact with said plastic material of said one inner sash member.

56. The patio door assembly of claim 55, wherein said first elongated reinforcing bar comprises a first flat reinforcing bar having a first side and a second side, and said second elongated reinforcing bar comprises a second flat reinforcing bar having a first side and a second side, said first flat reinforcing bar being arranged so that said first side thereof is in intimate contact with the injection molded plastic material of said intermediate member substantially along the length of said first flat reinforcing bar, and said second flat reinforcing bar being arranged so that said first side thereof is in intimate contact with said plastic material of said one inner sash member substantially along the length of said second flat reinforcing bar; and wherein said integral securing strap extends along a portion of the length of said first flat reinforcing bar about said second side of said flat reinforcing bar to form an integral strap arranged to extend across a portion of said second side of said first flat reinforcing bar, and said integral sash strap extends along a portion of the length of said second flat reinforcing bar about said second side of said second flat reinforcing bar to form an integral strap arranged to extend across a portion of said second side of said second flat reinforcing bar.

57. The patio door assembly of claim 54, wherein a plurality of securing straps are provided integrally formed with said intermediate member, and a plurality of integral sash straps are provided integrally formed with said one inner sash member.

58. The patio door assembly of claim 57, further including a first window unit disposed within said fixed outer reinforced patio door frame, and a second window unit disposed within said moveable inner reinforced patio door frame, said first window unit being supported at least in part by said plurality of securing straps provided on said intermediate member and said second window unit being supported at least in part by said plurality of integral sash straps provided on said one inner sash member.

59. The patio door assembly of claim 54, wherein at least a portion of said first reinforcing bar is visible in said intermediate member of said fixed outer reinforced patio door frame, and wherein at least a portion of said second reinforcing bar is visible in said one inner sash member of said moveable inner reinforced patio door frame.

60. A method of making a reinforced injection molded object from an injection moldable plastic material, said method comprising the steps of:
providing a mold having a mold cavity in a desired shape for injection molding said object, said mold including a support mechanism operable to engage a reinforcing member to support said reinforcing member in a predetermined position in said mold cavity so that said injection moldable plastic material will intimately contact said reinforcing member about at least a first portion of said reinforcing member, and said mold cavity also being constructed so that said injection moldable plastic material will extend about a second portion of said reinforcing member to form an integral retention member integrally formed with said injection moldable plastic material in intimate contact with said first portion of said reinforcing member for retaining said reinforcing member in intimate contact with said injection moldable plastic material;
placing a reinforcing member in said cavity and operating said support mechanism to engage said reinforcing member to support said reinforcing member in said mold cavity in said predetermined position;
injecting injection moldable plastic material in a viscous state into said mold cavity to intimately contact said reinforcing member;
allowing said viscous plastic material to solidify; and
disengaging said support mechanism from said reinforcing member and removing said solidified plastic material from said mold.

61. The method of claim 60, wherein said reinforcing member is a longitudinally extending reinforcing bar, and wherein said mold cavity is constructed so that said injection moldable plastic material will intimately contact said longitudinally extending reinforcing bar along substantially the length of said longitudinally extending reinforcing bar about a first part of the circumference of said longitudinally extending reinforcing bar, and also constructed so that said injection moldable plastic material will also extend along at least a portion of the length of said longitudinally extending reinforcing bar about a second part of the circumference of said longitudinally extending reinforcing bar so as to retain said longitudinally extending reinforcing bar in intimate contact with said injection moldable plastic material.

62. The method of claim 61, wherein said longitudinally extending reinforcing bar comprises a flat reinforcing bar having a first side and a second side, and wherein said mold cavity is constructed so that said injection moldable plastic material will contact said flat reinforcing bar along said first side, and also constructed so that said injection moldable plastic material will also extend about at least a portion of said second side of said flat reinforcing bar.

63. The method of claim 62, wherein said mold cavity is constructed so that said injection moldable plastic material will contact said first side of said flat reinforcing bar along substantially the length of said flat reinforcing bar.

64. The method of claim 62, wherein said flat reinforcing bar also has two edges extending between said first and second sides, and wherein said mold cavity is constructed so that said injection moldable plastic material will contact said first and second sides and one of said edges of said flat reinforcing bar along substantially the length of said flat reinforcing bar, and also constructed so that said injection moldable plastic material will also extend about at least a portion of the other of said edges of said flat reinforcing bar.

65. The method of claim 60, wherein said support mechanism comprises a magnet operable to magnetically hold said reinforcing member.

66. The method of claim 60, wherein said support mechanism comprises an electromagnet operable to magnetically hold said reinforcing member when said electromagnet is turned on and to disengage from said reinforcing bar when said electromagnet is turned off.

67. The method of claim 60, wherein said support mechanism comprises a retractable pin operable to move between an extended position in which it engages said reinforcing member and a retracted position in which it is disengaged from said reinforcing member.

68. The method of claim 60, wherein said support mechanism includes a pair of pin members, each moveable between an extended engagement position and a retracted disengagement position; wherein said step of placing a reinforcing member in said cavity and operating said support mechanism comprises moving said pin members to said extended position; and wherein said step of disengaging said support mechanism comprises moving said pin members to said retracted position.

69. The method of claim 60, wherein said step of removing said object from said mold comprises removing said object before said moveable plastic material is completed cured and allowing said plastic material to shrink after removal from said mold as said plastic material cures completely.

70. The method of claim 60, wherein said mold has a mold cavity in the shape of a rectangular door frame having a plurality of sash members connected to one another, and wherein said support member is operable to engage a reinforcing member to support said reinforcing member in a predetermined position in said mold cavity so that said reinforcing member will be in intimate contact with said injection moldable plastic material forming one of said sash members.

71. The method of claim 70, wherein said mold cavity is constructed to provide four sash members integrally formed and connected together at their respective ends to form the shape of a rectangle and an intermediate sash member integrally formed with said four sash members and extending between two of said sash members for forming said rectangular door frame, and wherein said support mechanism is operable to engage said reinforcing member to support said reinforcing member in said predetermined position in said mold cavity so that said reinforcing member is arranged along the portion of said cavity forming said intermediate sash member.

72. The method of claim 70, wherein said mold cavity is constructed to provide a rectangular frame having two sash styles and two sash rails integrally formed with one another and connected together at their respective ends, and wherein said support mechanism is operable to support said reinforcing member in said predetermined position in said mold cavity so as to be in the portion of said cavity forming one of said sash styles.

73. The method of claim 60, wherein said mold has a mold cavity in the shape of a table, and wherein said mold includes a plurality of support mechanisms operable to engage a plurality of reinforcing members to support said reinforcing members in predetermined positions in said mold cavity so that said injection moldable plastic material will intimately contact each of said reinforcing members about first portions of said reinforcing members, and said mold cavity being constructed so that said injection moldable plastic material will also extend about second portions of said reinforcing members to form integral retention members integrally formed with said injection moldable plastic material in intimate contact with said first portions of said reinforcing members for retaining said reinforcing members in intimate contact with said injection moldable plastic material.

74. The method of claim 60, wherein said mold has a mold cavity in the shape of a window having two sash rails and two sash styles, and wherein said support mechanism is operable to engage a reinforcing member to support said reinforcing member in a predetermined position in said mold cavity so that said reinforcing member will be in intimate contact with injection moldable plastic material forming one of said sash rails.

75. The method of claim 60, wherein said mold has a mold cavity in the shape of a bench, and wherein said mold cavity is constructed so that said reinforcing member when placed in said predetermined position is arranged to reinforce the seat of said bench.

76. The method of claim 60, wherein said mold comprises a two-part mold and wherein said predetermined position in said mold cavity is at least partially along the mold parting line between said two mold parts, whereby at least a portion of said reinforcing member is exposed after said object is removed from said mold, and wherein said integral retention member extends about a portion of the exposed part of said reinforcing member.

77. The method of claim 60, wherein said mold includes at least one stop member for aligning said reinforcing member in said predetermined position in said mold cavity.

78. The method of claim 60, wherein the dimension of said mold cavity at the position at which said reinforcing member is supported is greater than the length of said reinforcing member so as to allow for shrinkage of said plastic material about said reinforcing member as said plastic material solidifies.

79. A method of making a reinforced unitary door frame from an injection moldable plastic material, said method comprising the steps of:
providing a mold having a mold cavity in the shape of a rectangular door frame having a plurality of sash members connected to one another, said mold including a support mechanism operable to engage a reinforcing member to support said reinforcing member in a predetermined position in said mold cavity for reinforcing one of said sash members to be injection molded so that injection moldable plastic material will intimately contact said reinforcing member about at least a first portion of said reinforcing member, and said mold cavity being constructed so that said injection moldable plastic material will also extend about a second portion of said reinforcing member to form an integral retention member integrally formed with said injection moldable plastic material in intimate contact with said first portion of said reinforcing member for retaining said reinforcing member in intimate contact with said injection moldable plastic material;
placing a reinforcing member in said cavity and operating said support mechanism to engage said reinforcing member to support said reinforcing member in said mold cavity in said predetermined position;
injecting injection moldable plastic material in a viscous state into said mold cavity to intimately contact said reinforcing member;
allowing said viscous plastic material to solidify; and
disengaging said support mechanism from said reinforcing member and removing said solidified plastic material from said mold.

80. The method of claim 79, wherein said mold cavity is constructed to provide four sash members integrally formed and connected together at their respective ends to form the shape of a rectangle and an intermediate sash member integrally formed with said four sash members and extending between two of said sash members for forming said rectangular door frame, and wherein said support mechanism is operable to engage said reinforcing member to support said reinforcing member in said predetermined position in said mold cavity so that said reinforcing member is arranged along the portion of said cavity forming said intermediate sash member.

81. The method of claim 79, wherein said mold cavity is constructed to provide a rectangular frame having two sash styles and two sash rails integrally formed with one another and connected together at their respective ends, and wherein said support mechanism is operable to support said reinforcing member in said predetermined position in said mold cavity so as to be in the portion of said cavity forming one of said sash styles.

82. The method of claim 79, wherein said reinforcing member is a longitudinally extending reinforcing bar, and wherein said mold cavity is constructed so that said injection moldable plastic material will intimately contact said longitudinally extending reinforcing bar along substantially the length of said longitudinally extending reinforcing bar about a first part of the circumference of said longitudinally extending reinforcing bar, and also constructed so that said injection moldable plastic material will also extend along at least a portion of the length of said longitudinally extending reinforcing bar about a second part of the circumference of said longitudinally extending reinforcing bar so as to retain said longitudinally extending reinforcing bar in intimate contact with said injection moldable plastic material.

83. The method of claim 79, wherein said longitudinally extending reinforcing bar comprises a flat reinforcing bar having a first side and a second side, and wherein said mold cavity is constructed so that said injection moldable plastic material will contact said flat reinforcing bar along said first side, and also constructed so that said injection moldable plastic material will also extend about at least a portion of said second side of said flat reinforcing bar.

84. The method of claim 79, wherein said support mechanism comprises a magnet operable to magnetically hold said reinforcing member.

85. The method of claim 79, wherein said support mechanism comprises an electromagnet operable to magnetically hold said reinforcing member when said electromagnet is turned on and to disengage from said reinforcing bar when said electromagnet is turned off.

86. The method of claim 79, wherein said support mechanism comprises a retractable pin operable to move between an extended position in which it engages said reinforcing member and a retracted position in which it is disengaged from said reinforcing member.

87. The method of claim 79, wherein said support mechanism includes a pair of pin members, each moveable between an extended engagement position and a retracted disengagement position; wherein said step of placing a reinforcing member in said cavity and operating said support mechanism comprises moving said pin members to said extended position; and wherein said step of disengaging said support mechanism comprises moving said pin members to said retracted position.

88. The method of claim 79, wherein said step of removing said solidified plastic material from said mold comprises removing said solidified plastic material before said injection moldable plastic material is completed cured and allowing said plastic material to shrink after removal from said mold as said plastic material cures completely.

89. The method of claim 79, wherein said mold comprises a two-part mold and wherein said predetermined position in said mold cavity is at least partially along the mold parting line between said two mold parts, whereby at least a portion of said reinforcing member is exposed after said plastic material is removed from said mold; and wherein said integral retention member extends about a portion of the exposed part of said reinforcing member.

90. The method of claim 79, wherein said mold includes at least one stop member for aligning said reinforcing member in said predetermined position in said mold cavity.

91. The method of claim 79, wherein the dimension of said mold cavity at the position at which said reinforcing member is supported is greater than the length of said reinforcing member so as to allow for shrinkage of said plastic material about said reinforcing member as said plastic material solidifies.
